(19) United States
(12) Patent Application Publication
(10) Pub. No.: US 2024/0365404 A1
(43) Pub. Date: Oct. 31, 2024

(54) METHOD AND DEVICE FOR WIRELESS COMMUNICATION

(71) Applicant: GUANGDONG OPPO MOBILE TELECOMMUNICATIONS CORP., LTD., Dongguan (CN)

(72) Inventors: Chaoming LUO, Dongguan (CN); Lei HUANG, Singapore (SG)

(21) Appl. No.: 18/765,172

(22) Filed: Jul. 5, 2024

Related U.S. Application Data
(63) Continuation of application No. PCT/CN2022/080784, filed on Mar. 14, 2022.

(30) Foreign Application Priority Data
Jan. 7, 2022 (WO) PCT/CN2022/070831

(51) Int. Cl. H04W 76/10; H04W 76/30; H04W 84/12

(52) U.S. Cl. CPC H04W 76/10; H04W 76/30; H04W 84/12

(57) ABSTRACT

A method for wireless communication includes: receiving, by an STA, indication information transmitted by an AP, where the first indication information is used to indicate new measurement setup and/or measurement setup termination with the STA within a target duration.

This application is a Bypass Continuation application of PCT/CN2022/080784, filed on Mar. 14, 2020, which claims priority to PCT Patent Application No. PCT/CN2022/070831, entitled “WIRELESS COMMUNICATION METHOD, AND DEVICE”, filed to the China National Intellectual Property Administration on Jan. 7, 2022, which are incorporated herein by reference in their entirety.

### TECHNICAL FIELD

Embodiments of the present application relate to the field of communications, and in particular, to a method and device for wireless communication.

### BACKGROUND

Wireless local area network (WLAN) sensing refers to methods and applications for sensing people or objects in the environment by measuring changes in WLAN signals after scattered and/or reflected by people or objects. How to establish a sensing session is an urgent problem to be solved.

### SUMMARY

Embodiments of the present application provide a method and device for wireless communication.

In a first aspect, a method for wireless communication is provided. The method includes:
receiving, by a STA, first information; where
the first information is used to indicate whether an AP is searching for sensing responding devices of a first type, and/or the first information is used to indicate whether the AP supports the STA to participate in sensing functions of first type; and
the sensing responding devices of the first type include a secure sensing responding device and/or a non-secure sensing responding device, and the sensing functions of the first type include a secure sensing function and/or a non-secure sensing function.

In a second aspect, a method for wireless communication is provided. The method includes:
transmitting, by an AP, first information; where
the first information is used to indicate whether the AP is searching for sensing responding devices of a first type, and/or the first information is used to indicate whether the AP supports a STA to participate in sensing functions of a first type; and
the sensing responding devices of the first type include a secure sensing responding device and/or a non-secure sensing responding device, and the sensing functions of the first type includes a secure sensing function and/or a non-secure sensing function.

In a third aspect, a method for wireless communication is provided. The method includes:
receiving, by a STA, first indication information transmitted by an AP;
where the first indication information is used to indicate new measurement setup and/or measurement setup termination with the STA within a target duration.

In a fourth aspect, a method for wireless communication is provided. The method includes:
transmitting, by an AP, first indication information to a STA;
where the first indication information is used to indicate new measurement setup and/or measurement setup termination with the STA within a target duration.

In a fifth aspect, a station device is provided for performing the method of the first aspect.

In some embodiments, the station device includes a functional module for performing the method in the first aspect.

In a sixth aspect, an access point device is provided for performing the method in the second aspect.

In some embodiments, the access point device includes a functional module for performing the method in the second aspect.

In a seventh aspect, a station device is provided for performing the method of the third aspect.

In some embodiments, the station device includes a functional module for performing the method in the third aspect.

In an eighth aspect, an access point device is provided for performing the method in the fourth aspect.

In some embodiments, the access point device includes a functional module for performing the method in the fourth aspect.

In a ninth aspect, a station device is provided, including a processor and a memory. The memory is used to store a computer program, and the processor is used to invoke and execute the computer program stored in the memory, causing the station device to perform the method in the first aspect.

In a tenth aspect, an access point device is provided, including a processor and a memory. The memory is used to store a computer program, and the processor is used to invoke and execute the computer program stored in the memory, causing the access point device to perform the method in the second aspect above.

In an eleventh aspect, a station device is provided, including a processor and a memory. The memory is used to store a computer program, and the processor is used to invoke and execute the computer program stored in the memory, causing the station device to perform the method in the third aspect.

In a twelfth aspect, an access point device is provided, including a processor and a memory. The memory is used to store a computer program, and the processor is used to invoke and execute the computer program stored in the memory, causing the access point device to perform the method in the fourth aspect described above.

In a thirteenth aspect, an apparatus is provided for implementing the method in any one of the first aspect to the fourth aspect.

In some embodiments, the apparatus includes a processor configured to invoke and execute a computer program from a memory, causing a device installed with the apparatus performing the method in any one of the first aspect to the fourth aspect.

In a fourteenth aspect, a non-transitory computer readable storage medium is provided for storing a computer program, where the computer program causes a computer to perform the method in any one of the first aspect to the fourth aspect.

In a fifteenth aspect, a computer program product is provided, including computer program instructions, where the computer program instructions cause a computer to perform the method in any one of the first aspect to the fourth aspect.

In a sixteenth aspect, a computer program is provided, and the computer program, when executed by a computer, causes the computer to perform the method in any one of the first aspect to the fourth aspect.

### BRIEF DESCRIPTION OF THE DRAWINGS

FIG. 1 is a schematic diagram of a communication system architecture applied in embodiments of the present application.

FIG. 2 is a schematic diagram of WLAN sensing and participating devices provided by the present application.

FIG. 3 is a schematic interaction flow chart of a method for wireless communication in accordance with embodiments of the present application.

FIG. 4 is a schematic diagram of a sensing operation element in accordance with embodiments of the present application.

FIG. 5 is a schematic diagram of another sensing operation element in accordance with embodiments of the present application.

FIG. 6 is a schematic diagram of a robust security network element in accordance with embodiments of the present application.

FIG. 7 is a schematic diagram of an robust security network extension element in accordance with embodiments of the present application.

FIG. 8 is a schematic diagram of a sensing session setup request frame in accordance with embodiments of the present application.

FIG. 9 is a schematic diagram of a sensing probe request frame in accordance with embodiments of the present application.

FIG. 10 is a schematic diagram of a sensing session setup response frame in accordance with embodiments of the present application.

FIG. 11 is a schematic diagram of a sensing probe response frame in accordance with embodiments of the present application.

FIG. 12 is a schematic diagram of a sensing measurement setup request frame in accordance with embodiments of the present application.

FIG. 13 is a schematic diagram of a sensing measurement setup response frame in accordance with embodiments of the present application.

FIGS. 14 to 26 are schematic flow charts of sensing setup in accordance with embodiments of the present application.

FIG. 27 is a schematic interaction flow chart of another method for wireless communication in accordance with embodiments of the present application.

FIG. 28 is a schematic diagram of a measurement setup request frame in accordance with embodiments of the present application.

FIG. 29 is a schematic diagram of a polling trigger frame in accordance with embodiments of the present application.

FIG. 30 is a schematic diagram of another polling trigger frame in accordance with embodiments of the present application.

FIG. 31 is a schematic diagram of a sounding trigger frame in accordance with embodiments of the present application.

FIG. 32 is a schematic diagram of a sounding announcement frame in accordance with embodiments of the present application.

FIG. 33 is a schematic block diagram of a STA device in accordance with embodiments of the present application.

FIG. 34 is a schematic block diagram of an AP device in accordance with embodiments of the present application.

FIG. 35 is a schematic block diagram of another STA device in accordance with embodiments of the present application.

FIG. 36 is a schematic block diagram of another AP device in accordance with embodiments of the present application.

FIG. 37 is a schematic block diagram of a communication device in accordance with embodiments of the present application.

FIG. 38 is a schematic block diagram of an apparatus in accordance with embodiments of the present application.

FIG. 39 is a schematic block diagram of a communication system in accordance with embodiments of the present application.

### DETAILED DESCRIPTION

The technical solutions of the embodiments of the present application will be described below, in conjunction with the drawings of the embodiments of the present application. Obviously, the described embodiments are merely some but not all of embodiments of the present application. All other embodiments obtained based on the embodiments of the present application by a person of ordinary skill in the art shall be included in the protection scope of the present application.

The technical solutions of the embodiments of the present application may be applied to various communication systems, such as wireless local area network (WLAN), wireless fidelity (WiFi) or other communication systems.

For example, a communication system 100 in which the embodiments of the present application are applied is shown in FIG. 1. The communication system 100 may include an access point (AP) 110 and a station (STA) 120 which accesses a network through the AP 110.

In some scenarios, an AP may be referred to as an AP STA. That is, in a sense, the AP is also a STA. In some scenarios, a STA is also referred to as a non-AP STA.

In some embodiments, the STAs may include an AP STA and a non-AP STA.

A communication in the communication system 100 may be a communication between the AP and the STA, a communication between STAs, or a communication between a STA and another STA (peer STA). The peer STA may refer to a device that has a peer communication with the STA. For example, the peer STA may be an AP or a non-AP STA.

The AP is the equivalent of a bridge between wired and wireless networks, whose main role is to connect various wireless network clients together and then connect the wireless network to Ethernet. The AP device may be a terminal device (e.g., a mobile phone) or network device (e.g., a router) with a WiFi chip.

It should be understood that a role of the STA in the communication system is not fixed. For example, in some scenarios, in a case where a mobile phone is connected to a router, the mobile phone is the STA, and in a case where the mobile phone serves as a hotspot for other mobile phones, the mobile phone acts as the AP.

The AP and the STA may be devices applied in an Internet of Vehicles, Internet of Things (IoT) nodes, sensors, etc. in the IoT, smart cameras, smart remote controls, smart watermeters, smart electricity meters, etc. in a smart home, and sensors in a smart city, etc.

In some embodiments, the STA may support an 802.11be standard. The STA may also support various current and future 802.11 family WLAN standards, such as 802.11ax, 802.11ac, 802.11n, 802.11g, 802.11b and 802.11a.

In some embodiments, the AP may support the 802.11be standard. The AP may also support various current and future WLAN standards of the 802.11 family, such as 802.11ax, 802.11ac, 802.11n, 802.11g, 802.11b, and 802.11a.

In some embodiments, the AP 110 and/or the STA 120 may be deployed on land, including indoor or outdoor, handheld, wearable or vehicle-mounted; the AP 110 and/or the STA 120 may also be deployed on water (e.g., on a ship); the AP 110 and/or the STA 120 may also be deployed in the air (e.g., on an airplane, on a balloon, on a satellite).

In the embodiments of the present application, the STA 120 may be a mobile phone, a pad, a computer with wireless transceiver function, a virtual reality (VR) device, an augmented reality (AR) device, a wireless device in industrial control, a set-top box, a wireless device in self driving, a vehicle-mounted communication device, a wireless device in remote medical, a wireless device in smart grid, a wireless device in transportation safety, a wireless device in smart city, a wireless device in smart home, a vehicle-mounted communication device, a wireless communication chip/application-specific integrated circuit (ASIC)/system on chip (SoC), or the like, which supports the WLAN/WiFi technology.

By way of example and not limitation, in the embodiments of the present application, the STA 120 may also be a wearable device. The wearable device may also be referred to as a wearable smart device, which is a general term for wearable devices developed by using wearable technology and intelligent design for everyday wear, such as glasses, gloves, a watch, clothing, shoes, and the like. The wearable device is a portable device that is worn directly on a body, or integrated into a user's clothing or accessories. The wearable device is not only a hardware device, but also implements powerful functions through software support as well as data interaction or cloud interaction. Generalized wearable smart devices include full-featured, large-sized devices that may implement full or partial functionality without relying on smart phones, such as a smart watch or smart glasses, and devices that focus on a certain type of application functionality only and need to be used in conjunction with other devices such as smart phones, such as various smart bracelets, smart jewelries, and the like for monitoring physical signs.

The WLAN technology may support frequency bands that may include, but are not limited to: low frequency bands (e.g., 2.4 GHz, 5 GHZ, 6 GHZ), high frequency bands (e.g., 60 GHz).

FIG. 1 exemplarily shows one AP STA and two non-AP STAs. In some embodiments, the communication system 100 may include multiple APs and other numbers of STA, which are not limited in the embodiments of the present application.

It should be understood that a device in a network/system with a communication function in the embodiments of the present application may be referred to as a communication device. In an example of the communication system 100 shown in FIG. 1, the communication devices may include an AP 110 and STA 120 with the communication function. The AP 110 and the STA 120 may be devices described above and will not be repeated here. The communication devices may also include other devices in the communication system 100, such as a network controller, a gateway and other network entities, which are not limited in the embodiments of the present application.

It should be understood that terms “system” and “network” are often used interchangeably herein. The term “and/or” herein is only an association relationship to describe associated objects, indicating that there may be three relationships. For example, “A and/or B” may include: A alone, both A and B, and B alone. In addition, the character “/” herein generally indicates that related objects before and after this character are in an “or” relationship.

It should be understood that the “indicate” mentioned in the embodiments of the present application may mean a direct indication or an indirect indication, or represent that there is an association relationship. For example, A indicating B may mean that A directly indicates B, e.g., that B may be obtained through A; or it may mean that A indirectly indicates B, e.g., that A indicates C, and B may be obtained through C; or it may mean that there is an association relationship between A and B.

Terms used in the detailed description of the present application are only used to explain the embodiments of the present application and are not intended to limit the present application. Terms such as “first,” “second,” “third,” “fourth,” and the like in the description, claims and drawings of the present application are used to distinguish different objects rather than to describe a particular order. Furthermore, terms “include” and “have” and any derivations thereof are intended to cover non-exclusive inclusion.

The term “correspond” mentioned in the embodiments of the present application may mean a direct or indirect relationship between the two, or a relationship of association between the two, or a relationship of indicating and being indicated, or configuring and being configured, etc.

In embodiments of the present application, “predefined” or “preconfigured” may be implemented by pre-saving corresponding codes, tables or other means that may be used to indicate relevant information in devices (e.g., including a STA and a network device), the implementation of which is not limited in the present application. For example, predefined may mean defined in the protocol.

In the embodiments of the present application, the “protocol” may refer to a standard protocol in the field of communications. For example, the protocols may include a WiFi protocol and related protocols used in future WiFi communication systems, and the present application does not limit this.

To facilitate understanding of technical solutions of the embodiments of the present application, the technical solutions of the present application are described in detail below through some embodiments. The following related technologies, as optional solutions, may be arbitrarily combined with the technical solutions of the embodiments of the present application, and those combined solutions all fall within protection scope of the embodiments of the present application. The embodiments of the present application include at least part of the following content.

A wireless device supports multi-band communications, e.g., simultaneous communication on 2.4 GHz, 5 GHZ, 6 GHZ, and 60 GHz bands, or simultaneous communication on different channels in the same band (or different bands), to improve throughput and/or reliability of the communication between devices. Such a device is usually called a multi-band device, or a multi-link device (MLD), and is sometimes referred to as a multi-link entity or a multi-band entity. A multi-link device may be an access point device or a station device. If the multi-link device is the access point device, the multi-link device includes one or more APs; if the multi-link device is the station device, the multi-link device includes one or more non-AP STAs.

To facilitate understanding of the technical solutions of the embodiments of the present application, the technical solutions of the present application are described in detail below through some embodiments. The following related technologies, as optional solutions, may be arbitrarily combined with the technical solutions of the embodiments of the present application, and those combined solutions all fall within the protection scope of the embodiments of the present application. The embodiments of the present application include at least part of the following content.

In some embodiments, there may be multiple sensing types. For example, for a channel state information (CSI) based sensing type, namely CSI-based Sensing, a sensing measurement result is obtained by processing CSI of a received sensing measurement signal. For another example, for a reflected wave based sensing type, namely Radar-based Sensing, a sensing measurement result is obtained by processing reflected waves of a received sensing measurement signal.

A WLAN sensing session includes one or more of: session setup, sensing measurement setup (sensing measurement setup establishment), sensing measurement, sensing reporting, sensing measurement setup termination, and session termination.

Session setup phase: a sensing session is set up, sensing capabilities of both parties are exchanged and/or operating parameters related to sensing measurement are determined, or the terminal declares its own role and operating parameters (e.g., via a beacon frame or other special frames).

Sensing measurement setup phase (sensing measurement setup establishment phase): sensing participating devices and their roles (including a sensing signal transmitting device and a sensing signal receiving device) are determined, operating parameters related to the sensing measurement are determined, and optionally these parameters are exchanged between terminals.

Sensing measurement phase: a sensing measurement is implemented, and a sensing signal is transmitted by the sensing signal transmitting device to a sensing signal receiver.

Sensing reporting phase: measurement results are reported; depending on an application scenario, the sensing signal receiving device may need to report the measurement results to a sensing session initiating device.

Sensing measurement setup termination phase: one or more measurement setups are terminated, corresponding measurement is stop, and related storage and computing resources are released.

Session termination phase: all measurement setups are terminated, measurement is stopped, and the sensing session is terminated.

Data volume of sensing measurement results is usually relatively large. For example, data of channel state information (CSI) of a measurement may reach 4K to 40K bits. To reduce network load caused by reporting the sensing measurement results, a measurement threshold may be set. If the difference between a current sensing measurement result and a previous sensing measurement result is less than the measurement threshold, the sensing signal receiving device reports the sensing measurement result, otherwise it does not report the sensing measurement result.

The sensing session initiating device may set up multiple sets of measurement parameters using the measurement setup process. A set of measurement parameters (identified by a measurement setup identifier (ID), which may be equivalent to a burst group) may be applied to multiple measurements (identified by a measurement instance identifier (ID), which may be equivalent to a burst).

In some embodiments, only one pair of devices performs sensing measurement. That is, a non-trigger based (non-TB) measurement process is adopted. If the sensing initiating device is a sensing signal transmitting device, the sensing signal transmitting device may send a null data physical protocol data unit announcement (NDPA) frame to announce a start of measurement, and send a null data physical protocol data unit (NDP) frame after a short interframe space (SIFS) time. The sensing signal receiving device receives the NDP frame to generate a measurement result. After the SIFS time, the sensing signal receiving device reports the measurement result to the sensing initiating device. If the sensing initiating device is a sensing signal receiving device, the sensing signal transmitting device may send an NDPA frame to announce the start of measurement, and send an NDP frame after the SIFS time. The sensing signal receiving device receives the NDP frame to generate a measurement result without reporting the measurement result.

In some embodiments, multiple devices participate in the sensing measurement. To improve efficiency, a trigger based (TB) measurement process is generally adopted. In a polling phase, an AP sends a polling trigger frame to probe whether participating devices are available. In an uplink sensing sounding phase, the AP sends a trigger frame and an NDP frame. In downlink sensing sounding, the AP sends an NDPA frame and an NDP frame. In a reporting phase, a sensing transmitting device sends a feedback trigger frame after sending an NDP frame, and the sensing signal receiving device reports a measurement result to the sensing signal transmitting device after receiving the trigger frame.

In some embodiments, in sensing measurement, a measurement result is explicitly requested to be reported (e.g., triggered by a sensing feedback request frame or a sensing reporting trigger frame) or implicitly requested to be reported (e.g., triggered by an NDP) by the sensing initiating device. The measurement result may be reported immediately (immediate report) or delayed (delayed report). Generally, the delayed reporting is requested explicitly by the sensing initiating device.

To facilitate understanding of the technical solutions of the embodiments of the present application, terms related to the present application are explained below.

Association identifier (AID) is used to identify a terminal after it establishes an association with an access point.

Media access control (MAC) is short for media access control address.

Transmission opportunity (TXOP) refers to a period of time during which a terminal with the transmission opportunity may initiate one or more transmissions actively.

WLAN Sensing senses people or objects in the environment by measuring changes in WLAN signals after scattered and/or reflected by people or objects. That is, WLAN Sensing measures and senses the surrounding environment through wireless signals, so that it may perform many functions such as detection of indoor intrusion, movement and fall, posture recognition, creation of a spatial three-dimensional image, and the like.

WLAN devices participating in WLAN sensing may include the following roles:
sensing initiating device (Sensing Initiator): a device that initiates a sensing measurement and wants to know a sensing result;
sensing responding device (Sensing Responder): a non-sensing initiating device that participates in the sensing measurement;
sensing signal transmitting device (Sensing Transmitter) or sensing transmitting device: a device that transmits a sensing measurement signal (sensing illumination signal);
sensing signal receiving device (Sensing Receiver) or sensing receiving device: a device that receives the sensing measurement signal (sensing illumination signal);
sensing by proxy requesting device (Sensing by Proxy Requesting STA): a device that requests other devices to initiate a sensing measurement;
sensing proxy response device (Sensing by Proxy Responding STA) or sensing proxy device (Sensing Proxy STA): a device that responds to a request from the sensing by proxy requesting device and initiates the sensing measurement;
sensing processing device (Sensing processor): a device that processes a sensing measurement result;
sensing participating device (Sensing Participant): including the sensing initiating device, the sensing signal transmitting device and the sensing signal receiving device.

A WLAN terminal may play one or more roles in a sensing session. For example, a sensing initiating device may be just a sensing initiating device, or may be a sensing signal transmitting device, or may be a sensing signal receiving device, or may be both a sensing signal transmitting device and a sensing signal receiving device.

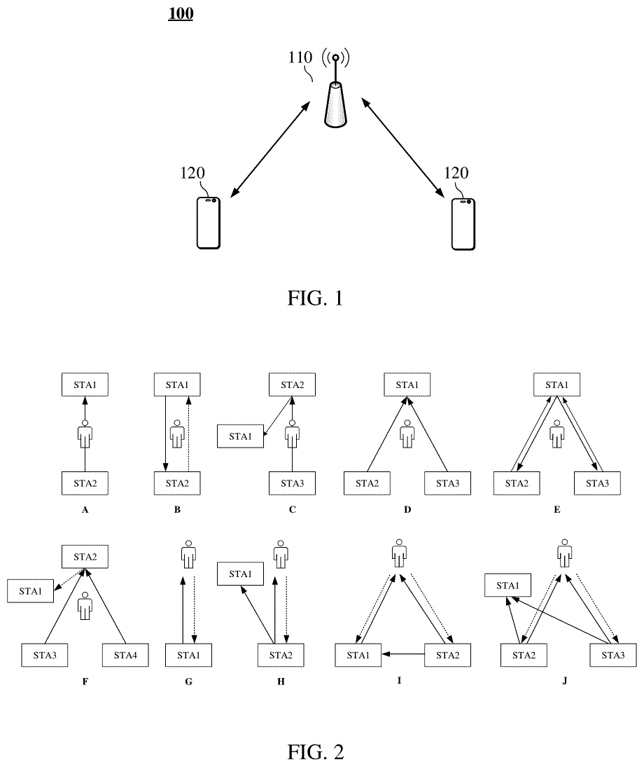

For example, as shown in A of FIG. 2, STA1 may be a sensing initiating device (Sensing Initiator), a sensing signal receiving device (Sensing Receiver), or a sensing processing device (Sensing Processor); STA2 may be a sensing signal transmitting device (Sensing Transmitter).

For another example, as shown in B of FIG. 2, STA1 may be a sensing initiating device (Sensing Initiator) or a sensing signal transmitting device (Sensing Transmitter); and STA2 may be a sensing signal receiving device (Sensing Receiver) or a sensing processing device (Sensing processor).

For another example, as shown in C of FIG. 2, STA1 may be a sensing initiating device (Sensing Initiator) or a sensing processing device (Sensing processor); STA2 may be a sensing signal receiving device (Sensing Receiver); and STA3 may be a sensing signal transmitting device (Sensing Transmitter).

For another example, as shown in D of FIG. 2, STA1 may be a sensing initiating device (Sensing Initiator), a sensing signal receiving device (Sensing Receiver), or a sensing processing device (Sensing processor); STA2 may be a sensing signal transmitting device (Sensing Transmitter); and STA3 may be a sensing signal transmitting device (Sensing Transmitter).

For another example, as shown in E of FIG. 2, STA1 may be a sensing initiating device (Sensing Initiator), a sensing signal transmitting device (Sensing Transmitter), or a sensing processing device (Sensing processor); STA2 may be a sensing signal receiving device (Sensing Receiver); and STA3 may be a sensing signal receiving device (Sensing Receiver).

For another example, as shown in F of FIG. 2, STA1 may be a sensing initiating device (Sensing Initiator); STA2 may be a sensing signal receiving device (Sensing Receiver) or a sensing processing device (Sensing processor); STA3 may be a sensing signal transmitting device (Sensing Transmitter); and STA4 may be a sensing signal transmitting device (Sensing Transmitter).

For another example, as shown in G of FIG. 2, STA1 may be a sensing initiating device (Sensing Initiator), a sensing signal transmitting device (Sensing Transmitter), a sensing signal receiving device (Sensing Receiver), or a sensing processing device (Sensing processor).

For another example, as shown in H of FIG. 2, STA1 may be a sensing initiating device (Sensing Initiator); STA2 may be a sensing signal transmitting device (Sensing Transmitter), a sensing signal receiving device (Sensing Receiver), or a sensing processing device (Sensing processor).

For another example, as shown in I of FIG. 2, STA1 may be a sensing initiating device (Sensing Initiator), a sensing signal transmitting device (Sensing Transmitter), a sensing signal receiving device (Sensing Receiver), or a sensing processing device (Sensing processor); and STA2 may be a sensing signal transmitting device (Sensing Transmitter) or a sensing signal receiving device (Sensing Receiver).

For another example, as shown in J of FIG. 2, STA1 may be a sensing initiating device (Sensing Initiator) or a sensing processing device (Sensing processor); STA2 may be a sensing signal transmitting device (Sensing Transmitter) or a sensing signal receiving device (Sensing Receiver); and STA3 may be a sensing signal transmitting device (Sensing Transmitter) or a sensing signal receiving device (Sensing Receiver).

It should be noted that FIG. 2 merely illustrates examples of the present application and should not be construed as a limitation to the present application. For example, STA1, STA2, and STA3 of FIG. 2 only represent roles of STAs, which are not used to limit the number of STAs in FIG. 2 and in subsequent steps such as sensing session and measurement. For example, the roles represented by STA1, STA2, and STA3 may be implemented as one or more STAs.

In some embodiments, there may be multiple sensing types. For example, for a channel state information (CSI) based sensing type, namely CSI-based Sensing, a sensing measurement result is obtained by processing CSI of a received sensing measurement signal. For another example, for a reflection signal based sensing type, namely Radar-based Sensing, a sensing measurement result is obtained by processing a reflection signal of a received sensing measurement signal.

A WLAN sensing session includes one or more of: session setup, sensing measurement setup, sensing measurement, sensing reporting, sensing measurement setup termination, and session termination.

Session setup phase: a sensing session is set up, sensing capabilities of both parties are exchanged and/or operating parameters related to sensing measurements are determined, or the terminal declares its own role and operating parameters (e.g., via a beacon frame or other special frames).

Sensing measurement setup phase: sensing participating devices and their roles (including a sensing signal transmitting device and a sensing signal receiving device) are determined, operating parameters related to the sensing measurement are determined, and these parameters are exchanged between terminals.

Sensing measurement phase: a sensing measurement is implemented, and a sensing signal is transmitted by the sensing signal transmitting device to the sensing signal receiver.

Sensing reporting phase: measurement results are reported; depending on an application scenario, the sensing signal receiving device may need to report the measurement results to a sensing session initiating device.

Sensing measurement setup termination phase: one or more measurement setups are terminated, corresponding measurements are stopped, and related storage and computing resources are released.

Session termination phase: all measurement setups are terminated, measurement is stopped, and the sensing session is terminated.

Data volume of sensing measurement results is usually relatively large. For example, data of channel state information (CSI) of a measurement may reach 4K to 40K bits. To reduce network load caused by reporting the sensing measurement results, a measurement threshold may be set. If the difference between a current sensing measurement result and a previous sensing measurement result is less than the measurement threshold, the sensing signal receiving device reports the sensing measurement result, otherwise it does not report the sensing measurement result.

The sensing initiating device may set up multiple sets of measurement parameters. A set of measurement parameters (identified by a measurement setup identifier (ID), which may be equivalent to a burst group) may be applied to multiple measurements (each measurement is identified by a measurement instance ID, which may be equivalent to a burst).

In some embodiments, the sensing session initiating device may set up the multiple sets of measurement parameters through a measurement setup procedure. A measurement setup, or called as measurement configuration, generally includes a set of measurement parameters, which may be identified by a measurement setup identifier (ID). A measurement setup may be applied to multiple measurements. A measurement (may be equivalent to a burst signal) may be considered as a measurement instance. The measurement instance may be identified by a measurement instance ID.

In the embodiments of the present application, a method for wireless communication is provided, which includes:
receiving, by a station (STA), first information;
where the first information is used to indicate whether an access point (AP) is searching for sensing responding devices of a first type, and/or the first information is used to indicate whether the AP supports the STA to participate in sensing functions of a first type; and
the sensing responding devices of the first type include a secure sensing responding device and/or a non-secure sensing responding device, and the sensing function of the first type include a secure sensing function and/or a non-secure sensing function.

In some embodiments, receiving, by the STA, the first information includes:
receiving, by the STA, the first information through passive scanning.

In some embodiments, the first information is transmitted via a first frame; and
the first frame is a beacon frame, or the first frame is a directional multi-gigabit (DMG) beacon frame.

In some embodiments, the first frame includes a sensing operation element and/or an robust security network extension element and/or a sensing capability element;
the sensing operation element includes a first indication field and a second indication field, the first indication field is used to indicate whether the AP is searching for the secure sensing responding device, and the second indication field is used to indicate whether the AP is searching for the non-secure sensing responding device;
the robust security network extension element includes a first indication field, and the first indication field is used to indicate whether the AP is searching for the secure sensing responding device; and
the sensing capability element includes a third indication field and a fourth indication field, the third indication field is used to indicate whether the AP supports the STA to participate in the secure sensing function, and the fourth indication field is used to indicate whether the AP supports the STA to participate in the non-secure sensing function.

In some embodiments, receiving, by the STA, the first information includes:
receiving, by the STA, the first information through active scanning.

In some embodiments, receiving, by the STA, the first information through the active scanning includes:
in a case where the STA supports the sensing functions of the first type and the STA initiates sensing measurement, receiving, by the STA, the first information through the active scanning; or
in a case where the STA supports the sensing functions of the first type and the STA is searching for a network, receiving, by the STA, the first information through the active scanning.

In some embodiments, the first information is transmitted via a probe response frame.

In some embodiments, the probe response frame includes a sensing operation element and/or an robust security network extension element and/or a sensing capability element;
the sensing operation element includes a first indication field and a second indication field, the first indication field is used to indicate whether the AP is searching for the secure sensing responding device, and
the second indication field is used to indicate whether the AP is searching for the non-secure sensing responding device;
the robust security network extension element includes a first indication field, and the first indication field is used to indicate whether the AP is searching for the secure sensing responding device; and
the sensing capability element includes a third indication field and a fourth indication field, the third indication field is used to indicate whether the AP supports the STA to participate in the secure sensing function, and the fourth indication field is used to indicate whether the AP supports the STA to participate in the non-secure sensing function.

In some embodiments, the sensing capability element further includes a fifth indication field, or the robust security network extension element further includes the fifth indication field;
the fifth indication field is used to indicate whether the AP supports secure sensing.

In some embodiments, the first indication field is a field for searching for the secure sensing responding device, and the second indication field is a field for searching for the non-secure sensing responding device.

In some embodiments, the STA is an unassociated STA with the AP, or the STA is an associated STA with the AP.

In some embodiments, if the first information is used to indicate that the AP is searching for the sensing responding devices of the first type, and/or the first information is used to indicate that the AP supports the STA to participate in the sensing functions of the first type, and the STA supports the sensing functions of the first type, the method further includes:
transmitting, by the STA, second information to the AP, where the second information includes communication capability information of the STA and sensing capability information of the STA;
receiving, by the STA, third information transmitted by the AP, where the third information includes communication capability information of the AP and sensing capability information of the AP.

In some embodiments, the sensing capability information of the STA includes at least one of: the STA supporting the secure sensing function or the STA supporting the non-secure sensing function.

In some embodiments, the sensing capability information of the AP includes at least one of: the AP supporting the secure sensing function, the AP supporting the non-secure sensing function, the AP supporting the STA to participate in the secure sensing function, or the AP supporting the STA to participate in the non-secure sensing function.

In some embodiments, the second information is transmitted via a second frame, and the third information is transmitted via a third frame;
where the second frame is a sensing session setup request frame, and the third frame is a sensing session setup response frame; or the second frame is a sensing probe request frame, and the third frame is a sensing probe response frame; or the second frame is a sensing variant probe request frame, and the third frame is a sensing variant probe response frame.

In some embodiments, the STA is an unassociated STA with the AP, and the third information further includes an unassociation identifier (UID) allocated by the AP to the STA.

In some embodiments, the second frame includes a sensing capability element, where the sensing capability element in the second frame is used to indicate at least one of: whether the STA supports the secure sensing function or whether the STA supports the non-secure sensing function.

In some embodiments, the third frame includes a sensing capability element and an unassociation identifier field;
where the sensing capability element in the third frame is used to indicate at least one of: whether the AP supports the secure sensing function, whether the AP supports the non-secure sensing function, whether the AP supports the STA to participate in the secure sensing function, or whether the AP supports the STA to participate in the non-secure sensing function; and
the unassociation identifier field is used to indicate the UID allocated by the AP to the STA.

In some embodiments, the third frame further includes a basic service set (BSS) maximum idle time element, where the BSS maximum idle time element is used to instruct the STA to automatically end a sensing session without interacting with the AP for a first time period.

In some embodiments, the second information is transmitted via a fourth frame, and the third information is transmitted via a fifth frame;
where the fourth frame is an association request frame, and the fifth frame is an association response frame; or the fourth frame is a reassociation request frame, and the fifth frame is a reassociation response frame.

In some embodiments, the STA is an associated STA with the AP, and the third information further includes an association identifier (AID) allocated by the AP to the STA.

In some embodiments, the fourth frame includes a sensing capability element, where the sensing capability element in the fourth frame is used to indicate at least one of: whether the STA supports the secure sensing function or whether the STA supports the non-secure sensing function.

In some embodiments, the fifth frame includes a sensing capability element and an association identifier field;
where the sensing capability element in the fifth frame is used to indicate at least one of: whether the AP supports the secure sensing function, whether the AP supports the non-secure sensing function, whether the AP supports the STA to participate in the secure sensing function, or whether the AP supports the STA to participate in the non-secure sensing function; and
the association identifier field is used to indicate the AID allocated by the AP to the STA.

In some embodiments, the method further including:
receiving, by the STA, fourth information transmitted by the AP, where
in a case where the STA is an unassociated STA with the AP, the fourth information is used to indicate a UID allocated by the AP to the STA; or
in a case where the STA is an associated STA with the AP, the fourth information is used to indicate an AID allocated by the AP to the STA.

In some embodiments, the fourth information is transmitted via a sixth frame, where
in a case where the AP initiates a sensing measurement setup, the sixth frame is a sensing measurement setup request frame; or
in a case where the STA initiates a sensing measurement setup, the sixth frame is a sensing measurement setup response frame.

In some embodiments, in a case where the STA is an unassociated STA with the AP and the sixth frame is the sensing measurement setup request frame, an action field in the sixth frame includes a response device information field, the response device information field includes a response device identifier field, and the response device identifier field is used to indicate the UID allocated by the AP to the STA; or
in a case where the STA is an associated STA with the AP and the sixth frame is the sensing measurement setup request frame, an action field in the sixth frame includes a response device information field, the response device information field includes a response device identifier field, and the response device identifier field is used to indicate the AID allocated by the AP to the STA.

In some embodiments, in a case where the STA is an unassociated STA with the AP and the sixth frame is the sensing measurement setup response frame, an action field in the sixth frame includes an unassociation identifier field, and the unassociation identifier field is used to indicate the UID allocated by the AP to the STA; or
in a case where the STA is an associated STA with the AP and the sixth frame is the sensing measurement setup response frame, an action field in the sixth frame includes an association identifier field, and the association identifier field is used to indicate the AID allocated by the AP to the STA.

In some embodiments, the method further including:
performing, by the STA, preassociation security negotiation (PASN) before establishing a sensing session; or
performing, by the STA, preassociation security negotiation (PASN) after establishing a sensing session.

In the embodiments, a method for wireless communication is provided, which including:
transmitting, by an access point (AP), first information,
where the first information is used to indicate whether the AP is searching for sensing responding devices of a first type, and/or the first information is used to indicate whether the AP supports a station (STA) to participate in sensing functions of a first type; and
the sensing responding devices of the first type include a secure sensing responding device and/or a non-secure sensing responding device, and the sensing functions of the first type includes a secure sensing function and/or a non-secure sensing function.

In some embodiments, the first information is received by the STA through passive scanning.

In some embodiments, the first information is transmitted via a first frame;
where the first frame is a beacon frame, or the first frame is a directional multi-gigabit (DMG) beacon frame.

In some embodiments, the first frame includes a sensing operation element and/or an robust security network extension element and/or a sensing capability element;
where the sensing operation element includes a first indication field and a second indication field, the first indication field is used to indicate whether the AP is searching for the secure sensing responding device, and the second indication field is used to indicate whether the AP is searching for the non-secure sensing responding device;
the robust security network extension element includes a first indication field, and the first indication field is used to indicate whether the AP is searching for the secure sensing responding device; and
the sensing capability element includes a third indication field and a fourth indication field, the third indication field is used to indicate whether the AP supports the STA to participate in the secure sensing function, and the fourth indication field is used to indicate whether the AP supports the STA to participate in the non-secure sensing function.

In some embodiments, the first information is received by the STA through active scanning.

In some embodiments, in a case where the STA supports the sensing functions of the first type and the STA initiates a sensing measurement, the first information is received by the STA through the active scanning; or
in a case where the STA supports the sensing functions of the first type and the STA is searching for a network, the first information is received by the STA through the active scanning.

In some embodiments, the first information is transmitted via a probe response frame.

In some embodiments, the probe response frame includes a sensing operation element and/or an robust security network extension element and/or a sensing capability element;
where the sensing operation element includes a first indication field and a second indication field, the first indication field is used to indicate whether the AP is searching for the secure sensing responding device, and the second indication field is used to indicate whether the AP is searching for the non-secure sensing responding device;
the robust security network extension element includes a first indication field, and the first indication field is used to indicate whether the AP is searching for the secure sensing responding device; and
the sensing capability element includes a third indication field and a fourth indication field, the third indication field is used to indicate whether the AP supports the STA to participate in the secure sensing function, and the fourth indication field is used to indicate whether the AP supports the STA to participate in the non-secure sensing function.

In some embodiments, the sensing capability element further includes a fifth indication field, or the robust security network extension element further includes the fifth indication field;
the fifth indication field is used to indicate whether the AP supports secure sensing.

In some embodiments, the first indication field is a field for searching for the secure sensing responding device, and the second indication field is a field for searching for the non-secure sensing responding device.

In some embodiments, the STA is an unassociated STA with the AP, or the STA is an associated STA with the AP.

In some embodiments, if the first information is used to indicate that the AP is searching for the sensing responding devices of the first type, and/or the first information is used to indicate that the AP supports the STA to participate in the sensing functions of the first type, and the STA supports the sensing functions of the first type, the method further includes:
receiving, by the AP, second information transmitted by the STA, where the second information includes communication capability information of the STA and sensing capability information of the STA;
transmitting, by the AP, third information to the STA, where the third information includes communication capability information of the AP and sensing capability information of the AP.

In some embodiments, the sensing capability information of the STA includes at least one of: the STA supporting the secure sensing function or the STA supporting the non-secure sensing function.

In some embodiments, the sensing capability information of the AP includes at least one of: the AP supporting the secure sensing function, the AP supporting the non-secure sensing function, the AP supporting the STA to participate in the secure sensing function, or the AP supporting the STA to participate in the non-secure sensing function.

In some embodiments, the second information is transmitted via a second frame, and the third information is transmitted via a third frame;
where the second frame is a sensing session setup request frame, and the third frame is a sensing session setup response frame; or the second frame is a sensing probe request frame, and the third frame is a sensing probe response frame; or the second frame is a sensing variant probe request frame, and the third frame is a sensing variant probe response frame.

In some embodiments, the STA is an unassociated STA with the AP, and the third information further includes an unassociation identifier (UID) allocated by the AP to the STA.

In some embodiments, the second frame includes a sensing capability element, where the sensing capability element in the second frame is used to indicate at least one of: whether the STA supports the secure sensing function or whether the STA supports the non-secure sensing function.

In some embodiments, the third frame includes a sensing capability element and an unassociation identifier field;
where the sensing capability element in the third frame is used to indicate at least one of: whether the AP supports the secure sensing function, whether the AP supports the non-secure sensing function, whether the AP supports the STA to participate in the secure sensing function, or whether the AP supports the STA to participate in the non-secure sensing functions; and
the unassociation identifier field is used to indicate the UID allocated by the AP to the STA.

In some embodiments, the third frame further includes a basic service set (BSS) maximum idle time element, where the BSS maximum idle time element is used to instruct the STA to automatically end a sensing session without interacting with the AP for a first time period.

In some embodiments, the second information is transmitted via a fourth frame, and the third information is transmitted via a fifth frame;
where the fourth frame is an association request frame, and the fifth frame is an association response frame; or the fourth frame is a reassociation request frame, and the fifth frame is a reassociation response frame.

In some embodiments, the STA is an associated STA with the AP, and the third information further includes an association identifier (AID) allocated by the AP to the STA.

In some embodiments, the fourth frame includes a sensing capability element, where the sensing capability element in the fourth frame is used to indicate at least one of: whether the STA supports the secure sensing function or whether the STA supports the non-secure sensing function.

In some embodiments, the fifth frame includes a sensing capability element and an association identifier field;
where the sensing capability element in the fifth frame is used to indicate at least one of: whether the AP supports the secure sensing function, whether the AP supports the non-secure sensing function, whether the AP supports the STA to participate in the secure sensing function, or whether the AP supports the STA to participate in the non-secure sensing function; and
the association identifier field is used to indicate the AID allocated by the AP to the STA.

In some embodiments, the method further including:
transmitting, by the AP, fourth information to the STA, where
in a case where the STA is an unassociated STA with the AP, the fourth information is used to indicate a UID allocated by the AP to the STA; or
in a case where the STA is an associated STA with the AP, the fourth information is used to indicate an AID allocated by the AP to the STA.

In some embodiments, the fourth information is transmitted via a sixth frame; where
in a case where the AP initiates a sensing measurement setup, the sixth frame is a sensing measurement setup request frame; or
in a case where the STA initiates a sensing measurement setup, the sixth frame is a sensing measurement setup response frame.

In some embodiments, in a case where the STA is an unassociated STA with the AP and the sixth frame is the sensing measurement setup request frame, an action field in the sixth frame includes a response device information field, the response device information field includes a response device identifier field, and the response device identifier field is used to indicate the UID allocated by the AP to the STA; or
in a case where the STA is an associated STA with the AP and the sixth frame is the sensing measurement setup request frame, an action field in the sixth frame includes a response device information field, the response device information field includes a response device identifier field, and the response device identifier field is used to indicate the AID allocated by the AP to the STA.

In some embodiments, in a case where the STA is an unassociated STA with the AP and the sixth frame is the sensing measurement setup response frame, an action field in the sixth frame includes an unassociation identifier field, and the unassociation identifier field is used to indicate the UID allocated by the AP to the STA; or
in a case where the STA is an associated STA with the AP and the sixth frame is the sensing measurement setup response frame, an action field in the sixth frame includes an association identifier field, and the association identifier field is used to indicate the AID allocated by the AP to the STA.

In some embodiments, the method further including:
performing, by the AP, preassociation security negotiation (PASN) before establishing a sensing session; or
performing, by the AP, preassociation security negotiation (PASN) after establishing a sensing session.

In the embodiments, a method for wireless communication is provided, which including:
receiving, by a station (STA), first indication information transmitted by an access point (AP);
where the first indication information is used to indicate new measurement setup and/or measurement setup termination with the STA within a target duration.

In some embodiments, the STA is an associated STA with the AP, or the STA is an unassociated STA with the AP.

In some embodiments, the first indication information is transmitted by the AP in a polling phase.

In some embodiments, the AP indicates that the STA will be polled in the polling phase when performing measurement setup with the STA; or
the AP defaults to polling the STA in the polling phase when performing measurement setup with the STA.

In some embodiments, the STA is an unassociated STA with the AP.

In some embodiments, the first indication information is transmitted via a polling trigger frame.

In some embodiments, the first indication information is transmitted by the AP in one of following phases:
a polling phase, an uplink sounding phase, a downlink sounding phase.

In some embodiments, if the polling phase exists, the first indication information is transmitted via a polling trigger frame; and/or
if the polling phase does not exist, the uplink sounding phase exists and the STA participates in uplink sounding, the first indication information is transmitted via a sounding trigger frame; and/or
if the polling phase does not exist, the downlink sounding phase exists and the STA participates in downlink sounding, the first indication information is transmitted via a sounding announcement frame.

In some embodiments, in a case where the AP indicates that the STA performs a threshold based reporting, the first indication information is transmitted via a threshold check polling frame.

In some embodiments, the polling trigger frame includes a field for whether there are more exchanges, where the field for whether there are more exchanges is used to indicate whether the AP intends to establish more measurement setups and/or terminate one or more existing measurement setups with the STA within the target duration.

In some embodiments, the polling trigger frame includes a field for whether there are more exchanges;
where the field for whether there are more exchanges includes a first subfield and a second subfield, the first subfield is used to indicate whether the AP intends to establish more measurement setups with the STA within the target duration, and the second subfield is used to indicate whether the AP intends to terminate one or more existing measurement setups with the STA within the target duration.

In some embodiments, the polling trigger frame includes a field for whether there are more measurement setups and a field for whether to terminate a measurement setup;
where the field for whether there are more measurement setups is used to indicate whether the AP intends to establish more measurement setups with the STA within the target duration, and the field for whether to terminate the measurement setup is used to indicate whether the AP intends to terminate a measurement setup corresponding to a measurement setup identifier in common information with the STA within the target duration.

In some embodiments, the sounding trigger frame includes a field for whether there are more measurement setups, where the field for whether there are more measurement setups is used to indicate whether the AP intends to establish more measurement setups with the STA within the target duration; or
the sounding trigger frame includes a field for whether there are more exchanges, where the field for whether there are more exchanges includes a first subfield and a second subfield, the first subfield is used to indicate whether the AP intends to establish more measurement setups with the STA within the target duration, and the second subfield is used to indicate whether the AP intends to terminate one or more existing measurement setups with the STA within the target duration.

In some embodiments, the sounding announcement frame includes a field for whether it is used for sensing and a field for whether there are more measurement setups;
where the field for whether it is used for sensing is used to indicate whether the sounding announcement frame is a sounding announcement frame for sensing, and the field for whether there are more measurement setups is used to indicate whether the AP intends to establish more measurement setups with the STA within the target duration.

In some embodiments, the sounding announcement frame includes a field for whether it is used for sensing and a field for whether there are more exchanges;
where the field for whether it is used for sensing is used to indicate whether the sounding announcement frame is a sounding announcement frame for sensing, and the field for whether there are more exchanges includes a first subfield and a second subfield, the first subfield is used to indicate whether the AP intends to establish more measurement setups with the STA within the target duration, and the second subfield is used to indicate whether the AP intends to terminate one or more existing measurement setups with the STA within the target duration.

In some embodiments, in a trigger based measurement instance and/or in a non-trigger based measurement instance, the first indication information is transmitted via a sensing reporting trigger frame, and/or, the first indication information is transmitted via a sensing reporting frame.

In some embodiments, in a case where the AP needs to request the STA to transmit a sensing reporting, the first indication information is transmitted via the sensing reporting trigger frame; and/or in a case where the AP transmits a sensing reporting to the STA, the first indication information is transmitted via the sensing reporting frame.

In some embodiments, the first indication information is transmitted via a measurement setup request frame transmitted by the AP to establish a target measurement setup with the STA.

In some embodiments, in a case where the STA, as a sensing initiating device, actively establishes a measurement setup with the AP, the first indication information is transmitted via a measurement setup response frame.

In some embodiments, in a case where the STA, as a sensing by proxy requesting device, transmits a sensing by proxy request frame to the AP, the first indication information is transmitted via a sensing by proxy response frame; and/or
after the STA, as the sensing by proxy requesting device sensing by proxy requesting device, actively initiates a sensing by proxy process with the AP, when the STA requests a sensing by proxy reporting from the AP, the first indication information is transmitted via a sensing by proxy reporting frame.

In some embodiments, a frame carrying the first indication information includes at least a field for whether there are more exchanges;
where the field for whether there are more exchanges is used to indicate whether the AP intends to establish more measurement setups and/or intends to terminate one or more existing measurement setups with the STA within the target duration.

In some embodiments, a frame carrying the first indication information includes at least a field for whether there are more exchanges;
where the field for whether there are more exchanges includes a first subfield and a second subfield, the first subfield is used to indicate whether the AP intends to establish more measurement setups with the STA within the target duration, and the second subfield is used to indicate whether the AP intends to terminate one or more existing measurement setups with the STA within the target duration.

In some embodiments, the method further including:
after receiving the first indication information, the STA remaining available within the target duration to receive measurement setup information and/or measurement setup termination information from the AP.

In some embodiments, the method further including:
after receiving the first indication information, transmitting, by the STA, an indication frame to the AP within the target duration;
where the indication frame is used to trigger the AP to establish one or more new measurement setups and/or terminate one or more existing measurement setups with the STA.

In some embodiments, the indication frame is allowed to not carry capability information required for sensing session setup.

In some embodiments, the indication frame is a sensing session setup request frame or a sensing capability information frame or a responder device information frame, or the indication frame is a newly defined action frame.

In some embodiments, the method further including:
transmitting, by the STA, first capability information to the AP, where the first capability information is used to indicate whether the STA supports measurement that does not need polling.

In some embodiments, the method further including:
receiving, by the STA, second indication information transmitted by the AP, where the second indication information is used to indicate whether the AP polls the STA in a polling phase.

In some embodiments, in a case where the STA does not support measurement that does not need polling, the AP does not establish a measurement setup with the STA, or the AP indicates to poll the STA in the polling phase in a process of establishing a measurement setup with the STA; or
in a case where the STA supports measurement that does not need polling, the AP indicates to poll the STA in the polling phase in a process of establishing a measurement setup with the STA, or the AP indicates not to poll the STA in the polling phase in the process of establishing the measurement setup with the STA.

In some embodiments, the second indication information is transmitted via a measurement setup request frame;
where the measurement setup request frame includes a field for whether to be polled, and the field for whether to be polled is used to indicate whether the STA will be polled in a polling phase of a trigger based measurement instance.

In some embodiments, the measurement setup request frame further includes a field for whether there are more exchanges;
where the field for whether there are more exchanges is used to indicate whether the AP intends to establish more measurement setups and/or intends to terminate one or more existing measurement setups with the STA within the target duration; or, the field for whether there are more exchanges includes a first subfield and a second subfield, the first subfield is used to indicate whether the AP intends to establish more measurement setups with the STA within the target duration, and the second subfield is used to indicate whether the AP intends to terminate one or more existing measurement setups with the STA within the target duration.

In some embodiments, the target duration is a predefined timeout period, or the target duration is a timeout period indicated by the AP.

In the embodiments, a method for wireless communication, which including:
transmitting, by an access point (AP), first indication information to a station (STA);
where the first indication information is used to indicate new measurement setup and/or measurement setup termination with the STA within a target duration.

In some embodiments, the STA is an associated STA with the AP, or the STA is an unassociated STA with the AP.

In some embodiments, the first indication information is transmitted by the AP in a polling phase.

In some embodiments, the AP indicates that the STA will be polled in the polling phase when performing measurement setup with the STA; or
the AP defaults to polling the STA in the polling phase when performing measurement setup with the STA.

In some embodiments, the STA is an unassociated STA with the AP.

In some embodiments, the first indication information is transmitted via a polling trigger frame.

In some embodiments, the first indication information is transmitted by the AP in one of following phases:
a polling phase, an uplink sounding phase, an downlink sounding phase.

In some embodiments, if the polling phase exists, the first indication information is transmitted via a polling trigger frame; and/or
if the polling phase does not exist, the uplink sounding phase exists and the STA participates in uplink sounding, the first indication information is transmitted via a sounding trigger frame; and/or
if the polling phase does not exist, the downlink sounding phase exists and the STA participates in downlink sounding, the first indication information is transmitted via a sounding announcement frame.

In some embodiments, in a case where the AP indicates that the STA performs a threshold based reporting, the first indication information is transmitted via a threshold check polling frame.

In some embodiments, the polling trigger frame includes a field for whether there are more exchanges; where the field for whether there are more exchanges is used to indicate whether the AP intends to establish more measurement setups and/or intends to terminate one or more existing measurement setups with the STA within the target duration.

In some embodiments, the polling trigger frame includes a field for whether there are more exchanges;
where the field for whether there are more exchanges includes a first subfield and a second subfield, the first subfield is used to indicate whether the AP intends to establish more measurement setups with the STA within the target duration, and the second subfield is used to indicate whether the AP intends to terminate one or more existing measurement setups with the STA within the target duration.

In some embodiments, the polling trigger frame includes a field for whether there are more measurement setups and a field for whether to terminate a measurement setup;
where the field for whether there are more measurement setups is used to indicate whether the AP intends to establish more measurement setups with the STA within the target duration, and the field for whether to terminate the measurement setup is used to indicate whether the AP intends to terminate a measurement setup corresponding to a measurement setup identifier in common information with the STA within the target duration.

In some embodiments, the sounding trigger frame includes a field for whether there are more measurement setups, where the field for whether there are more measurement setups is used to indicate whether the AP intends to establish more measurement setups with the STA within the target duration; or
the sounding trigger frame includes a field for whether there are more exchanges, the field for whether there are more exchanges includes a first subfield and a second subfield, the first subfield is used to indicate whether the AP intends to establish more measurement setups with the STA within the target duration, and the second subfield is used to indicate whether the AP intends to terminate one or more existing measurement setups with the STA within the target duration.

In some embodiments, the sounding announcement frame includes a field for whether it is used for sensing and a field for whether there are more measurement setups;
where the field for whether it is used for sensing is used to indicate whether the sounding announcement frame is a sounding announcement frame for sensing, and the field for whether there are more measurement setups is used to indicate whether the AP intends to establish more measurement setups with the STA within the target duration.

In some embodiments, the sounding announcement frame includes a field for whether it is used for sensing and a field for whether there are more exchanges;
where the field for whether it is used for sensing is used to indicate whether the sounding announcement frame is a sounding announcement frame for sensing, the field for whether there are more exchanges includes a first subfield and a second subfield, the first subfield is used to indicate whether the AP intends to establish more measurement setups with the STA within the target duration, and the second subfield is used to indicate whether the AP intends to terminate one or more existing measurement setups with the STA within the target duration.

In some embodiments, in a trigger based measurement instance and/or in a non-trigger based measurement instance, the first indication information is transmitted via a sensing reporting trigger frame, and/or, the first indication information is transmitted via a sensing reporting frame.

In some embodiments, in a case where the AP needs to request the STA to transmit a sensing reporting, the first indication information is transmitted via the sensing reporting trigger frame; and/or
in a case where the AP transmits a sensing reporting to the STA, the first indication information is transmitted via the sensing reporting frame.

In some embodiments, the first indication information is transmitted via a measurement setup request frame transmitted by the AP to establish a target measurement setup with the STA.

In some embodiments, in a case where the STA, as a sensing initiating device, actively establishes a measurement setup with the AP, the first indication information is transmitted via a measurement setup response frame.

In some embodiments, in a case where the STA, as a sensing by proxy requesting device, transmits a sensing by proxy request frame to the AP, the first indication information is transmitted via a sensing by proxy response frame; and/or
after the STA, as the sensing by proxy requesting device, actively initiates a sensing by proxy process with the AP, when the STA requests a sensing by proxy reporting from the AP, the first indication information is transmitted via a sensing by proxy reporting frame.

In some embodiments, a frame carrying the first indication information includes at least a field for whether there are more exchanges;
where the field for whether there are more exchanges is used to indicate whether the AP intends to establish more measurement setups and/or intends to terminate one or more existing measurement setups with the STA within the target duration.

In some embodiments, a frame carrying the first indication information includes at least a field for whether there are more exchanges;
where the field for whether there are more exchanges includes a first subfield and a second subfield, the first subfield is used to indicate whether the AP intends to establish more measurement setups with the STA within the target duration, and the second subfield is used to indicate whether the AP intends to terminate one or more existing measurement setups with the STA within the target duration.

In some embodiments, the method further including:
transmitting, by the AP, measurement setup information and/or measurement setup termination information to the STA within the target duration;
where the STA remains available within the target duration.

In some embodiments, the method further including:
receiving, by the AP, an indication frame transmitted by the STA within the target duration;
where the indication frame is used to trigger the AP to establish one or more new measurement setups and/or terminate one or more existing measurement setups with the STA.

In some embodiments, the indication frame is allowed to not carry capability information required for sensing session setup.

In some embodiments, the indication frame is a sensing session setup request frame or a sensing capability information frame or a responder device information frame, or the indication frame is a newly defined action frame.

In some embodiments, the method further including:
receiving, by the AP, first capability information transmitted by the STA, where the first capability information is used to indicate whether the STA supports measurement that does not need polling.

In some embodiments, the method further including:
transmitting, by the AP, second indication information to the STA, where the second indication information is used to indicate whether the AP polls the STA in a polling phase.

In some embodiments, in a case where the STA does not support measurement that does not need polling, the AP does not establish a measurement setup with the STA, or the AP indicates to poll the STA in the polling phase in a process of establishing a measurement setup with the STA; or
in a case where the STA supports measurement that does not need polling, the AP indicates to poll the STA in the polling phase in the process of establishing a measurement setup with the STA, or the AP indicates not to poll the STA in the polling phase in the process of establishing the measurement setup with the STA.

In some embodiments, the second indication information is transmitted via a measurement setup request frame;
where the measurement setup request frame includes a field for whether to be polled, and the field for whether to be polled is used to indicate whether the STA will be polled in a polling phase of a trigger based measurement instance.

In some embodiments, the measurement setup request frame further includes a field for whether there are more exchanges;
where the field for whether there are more exchanges is used to indicate whether the AP intends to establish more measurement setups and/or intends to terminate one or more existing measurement setups with the STA within the target duration; or, the field for whether there are more exchanges includes a first subfield and a second subfield, the first subfield is used to indicate whether the AP intends to establish more measurement setups with the STA within the target duration, and the second subfield is used to indicate whether the AP intends to terminate one or more existing measurement setups with the STA within the target duration.

In some embodiments, the target duration is a predefined timeout period, or the target duration is a timeout period indicated by the AP.

The technical solutions of the present application are described in detail below through some embodiments.

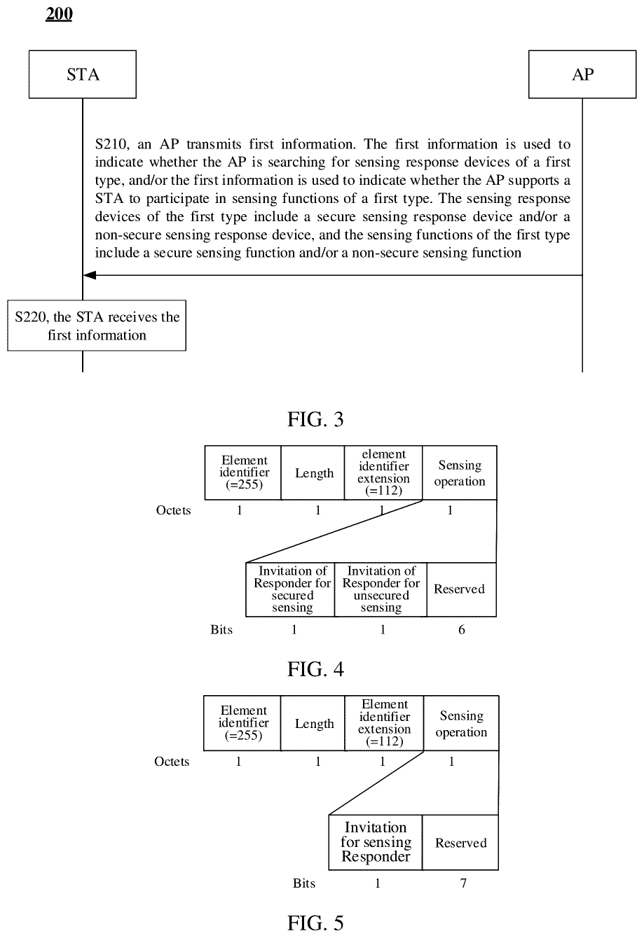

FIG. 3 is a schematic interaction diagram of a method for wireless communication 200 in accordance with embodiments of the present application. As shown in FIG. 3, the method for wireless communication 200 may include at least part of the following content:
in S210, an AP transmits first information. The first information is used to indicate whether the AP is searching for sensing responding devices of a first type, and/or the first information is used to indicate whether the AP supports a STA to participate in sensing functions of a first type. The sensing responding devices of the first type include a secure sensing responding device and/or a non-secure sensing responding device, and the sensing functions of the first type include a secure sensing function and/or a non-secure sensing function;
in S220, the STA receives the first information.

In the embodiments of the present application, the AP may indicate, through the first information, whether it is searching for the secure sensing responding device and/or the non-secure sensing responding device, and/or the AP may indicate, through the first information, whether it supports the STA to participate in the secure sensing function and/or the non-secure sensing function, so that the STA which has received the first information may participate in the sensing session based on the indication from the AP and establish the sensing session.

For example, the AP may indicate, through the first information, that the AP is searching for the secure sensing responding device. If the STA which has received the first information supports the secure sensing function and is willing to participate in a sensing measurement, the STA may establish a sensing session with the AP and then participate in a sensing measurement setup initiated by the AP.

For another example, the AP may indicate, through the first information, that the AP is searching for the non-secure sensing responding device. If the STA which has received the first information supports the non-secure sensing function and is willing to participate in a sensing measurement, the STA may establish a sensing session with the AP and then participate a sensing measurement setup initiated by the AP.

For another example, the AP may indicate, through the first information, that the AP supports the STA to participate in the secure sensing function. If the STA which has received the first information supports the secure sensing function and is willing to participate in a sensing measurement, the STA may establish a sensing session with the AP and then participate in a sensing measurement setup initiated by the AP.

For another example, the AP may indicate, through the first information, that the AP supports the STA to participate in the non-secure sensing function. If the STA which has received the first information supports the non-secure sensing function and is willing to participate in a sensing measurement, the STA may establish a sensing session with the AP and then participate in a sensing measurement setup initiated by the AP.

For another example, the AP may indicate, through the first information, that the AP is searching for the secure sensing responding device and that the AP supports the STA to participate in the secure sensing function. If the STA which has received the first information supports the secure sensing function and is willing to participate in a sensing measurement, the STA may establish a sensing session with the AP and then participate in a sensing measurement setup initiated by the AP.

For another example, the AP may indicate, through the first information, that the AP is searching for the non-secure sensing responding device and that the AP supports the STA to participate in the non-secure sensing function. If the STA which has received the first information supports the non-secure sensing function and is willing to participate in a sensing measurement, the STA may establish a sensing session with the AP and then participate in a sensing measurement setup initiated by the AP.

It should be noted that, in the embodiments of the present application, “search” may also be referred to as “invite”.

In some embodiments, the AP may transmit the first information via broadcast or multicast, or the AP may transmit the first information via unicast. The present application is not limited to this.

In the embodiments of the present application, the first information may update at different times, but it is not part of critical update information (critical update), and therefore does not cause a STA in the power saving mode to be woken up frequently.

In the embodiments of the present application, “field” may also be referred to as “subcategory”, which is not limited in the present application.

In some embodiments, the STA is an unassociated STA with the AP, or the STA is an associated STA with the AP.

For example, in a case where the number of associated STAs supporting a sensing function in a basic service set (BSS) is small, the AP may require an unassociated STA supporting the sensing function to participate in a sensing measurement.

For another example, in a case where a certain sensing function requires as many sensing participating devices as possible, the AP may require an unassociated STA supporting the sensing function to participate in a sensing measurement.

In some embodiments, the STA receives the first information through passive scanning. That is, in S220, the STA may receive the first information by passive scanning. For example, the STA monitors and receives the first information transmitted by the AP. In this case, the STA may be an unassociated STA with the AP, or the STA may be an associated STA with the AP.

In some embodiments, in a case where the STA receives the first information through passive scanning, the first information is transmitted via a first frame. The first frame is a beacon frame, or the first frame is a directional multi-gigabit (DMG) beacon frame.

In some implementations, the first frame includes a sensing operation element and/or an robust security network extension element and/or a sensing capability element. The sensing operation element includes a first indication field and a second indication field, the first indication field is used to indicate whether the AP is searching for the secure sensing responding device, and the second indication field is used to indicate whether the AP is searching for the non-secure sensing responding device. The robust security network extension element includes a first indication field, and the first indication field is used to indicate whether the AP is searching for the secure sensing responding device; the sensing capability element includes a third indication field and a fourth indication field, the third indication field is used to indicate whether the AP supports the STA to participate in the secure sensing function, and the fourth indication field is used to indicate whether the AP supports the STA to participate in the non-secure sensing function. Of course, the first frame may also include some other elements or fields, which is not limited in the present application.

In some embodiments, the STA receives the first information through active scanning. That is, in S220, the STA may receive the first information by active scanning. For example, a STA supporting the secure and/or non-secure sensing function needs to initiate sensing measurement, so the STA performs active scanning to discover an AP, and receives the first information during the active scanning. For another example, the STA supporting the secure and/or non-secure sensing function attempts to find a network to be connected to during roaming or pre-searches for an alternative network for roaming, so the STA performs active scanning to discover an AP and receives the first information during the active scanning. In this case, the STA may be an unassociated STA with the AP, or the STA may be an associated STA with the AP.

In some implementations, in a case where the STA supports the sensing functions of the first type and the STA initiates sensing measurement, the STA receives the first information through active scanning.

In some implementations, in a case where the STA supports the sensing functions of the first type and the STA is searching for a network, the STA receives the first information through active scanning.

In some embodiments, in a case where the STA receives the first information through the active scanning, the first information is transmitted via a probe response frame. In some implementations, the probe response frame includes a sensing operation element and/or an robust security network extension element and/or a sensing capability element. The sensing operation element includes a first indication field and a second indication field, the first indication field is used to indicate whether the AP is searching for the secure sensing responding device, and the second indication field is used to indicate whether the AP is searching for the non-secure sensing responding device. The robust security network extension element includes a first indication field, and the first indication field is used to indicate whether the AP is searching for the secure sensing responding device. The sensing capability element includes a third indication field and a fourth indication field, the third indication field is used to indicate whether the AP supports the STA to participate in the secure sensing function, and the fourth indication field is used to indicate whether the AP supports the STA to participate in the non-secure sensing function. Of course, the probe response frame may also include some other elements or fields, which is not limited in the present application.

In some implementations, the first indication field is a field for searching for the secure sensing responding device, and the second indication field is a field for searching for the non-secure sensing responding device.

In some implementations, the sensing capability element further includes a fifth indication field, or the robust security network extension element further includes the fifth indication field. The fifth indication field is used to indicate whether the AP supports secure sensing. For example, a value of 0 in the fifth indication field indicates that the AP supports the secure sensing, and a value of 1 in the fifth indication field indicates that the AP does not support the secure sensing. For another example, a value of 1 in the fifth indication field indicates that the AP supports the secure sensing, and a value of 0 in the fifth indication field indicates that the AP does not support the secure sensing.

In some implementations, for example, a value of 0 in the first indication field indicates that the AP is searching for the secure sensing responding device, and a value of 1 in the first indication field indicates that the AP is not searching for the secure sensing responding device. For another example, a value of 1 in the first indication field indicates that the AP is searching for the secure sensing responding device, and a value of 0 in the first indication field indicates that the AP is not searching for the secure sensing responding device.

In some implementations, for example, a value of 0 in the second indication field indicates that the AP is searching for the non-secure sensing responding device, and a value of 1 in the second indication field indicates that the AP is not searching for the non-secure sensing responding device. For another example, a value of 1 in the second indication field indicates that the AP is searching for the non-secure sensing responding device, and a value of 0 in the second indication field indicates that the AP is not searching for the non-secure sensing responding device.

In some implementations, for example, a value of 0 in the third indication field indicates that the AP supports the STA to participate in the secure sensing function, and a value of 1 in the third indication field indicates that the AP does not support the STA to participate in the secure sensing function. For another example, a value of 1 in the third indication field indicates that the AP supports the STA to participate in the secure sensing function, and a value of 0 in the third indication field indicates that the AP does not support the STA to participate in the secure sensing function.

In some implementations, for example, a value of 0 in the fourth indication field indicates that the AP supports the STA to participate in the non-secure sensing function, and a value of 1 in the fourth indication field indicates that the AP does not support the STA to participate in the non-secure sensing function. For another example, a value of 1 in the fourth indication field indicates that the AP supports the STA to participate in the non-secure sensing functions, and a value of 0 in the fourth indication field indicates that the AP does not support the STA to participate in the non-secure sensing function.

In some implementations, the sensing operation element may be as shown in FIG. 4. In some embodiments, a new extended element is defined, an element identifier extension value of which is 112 (it may also be any other value between 111 and 255). The sensing operation element may be included in a beacon frame and/or a DMG beacon frame and/or a probe response frame transmitted by the AP. As shown in FIG. 4, a sensing operation field of the sensing operation element indicates operation information related to sensing.

As shown in FIG. 4, an indication bit for searching for secure sensing responding device (Invitation of Responder for secured sensing) in the sensing operation field indicates whether the AP is searching for a sensing responding device that supports the secure sensing function. For example, it is set to 1 for yes, otherwise it is set to 0. For another example, it is set to 0 for yes, otherwise it is set to 1. For example, the AP needs 5 sensing responding devices that support the secure sensing function, but there are only 3 associated sensing responding devices in the current system. In this case, the AP may indicate in the beacon frame and/or the DMG beacon frame and/or the probe response frame that the AP is searching for available sensing responding devices that support the secure sensing function. After a station device that supports the secure sensing function receives indication information, it may initiate a sensing session.

As shown in FIG. 4, an indication bit for searching for non-secure sensing responding device (Invitation of Responder for unsecured sensing) in the sensing operation field indicates whether the AP is searching for a sensing responding device that supports the non-secure sensing function. For example, it is set to 1 for yes, otherwise it is set to 0. For another example, it is set to 0 for yes, otherwise it is set to 1. For example, the AP needs 5 sensing responding devices that support the non-secure sensing function, but there are only 3 associated sensing responding devices in the current system. In this case, the AP may indicate in the beacon frame and/or the DMG beacon frame and/or the probe response frame that the AP is searching for available sensing responding devices that support the non-secure sensing function. After a station device that supports the non-secure sensing function receives indication information, it may initiate a sensing session.

In some implementations, as shown in FIGS. 5, 6 and 7, a sensing operation element, a robust security network element (RSNE), and an robust security network extension element (RSNXE) may be used in combination. The three may be included in the beacon frame (Beacon) and/or the DMG beacon frame and/or probe response frame (Probe Response) transmitted by the AP.

In some embodiments, as shown in FIG. 5, an indication bit for invitation for sensing responding device (Invitation for sensing Responder) in the sensing operation field indicates whether the AP is inviting devices that support a sensing function to participate in sensing. In an embodiment, it is set to 1 for Yes, otherwise it is set to 0. In another embodiment, it may also be set to 0 for yes, otherwise it is set to 1.

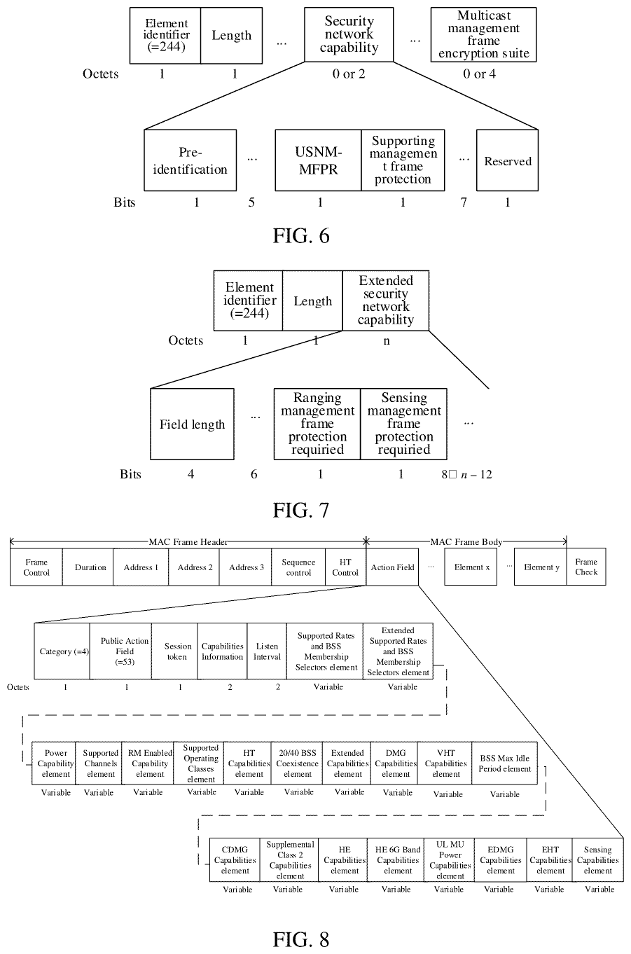

In some embodiments, as shown in FIGS. 6 and 7, an indication bit for sensing management frame protection required (Unassociated Sensing Negotiation and Measurement Management Frame Protection Required, USNM-MFPR) indicates whether the AP requires protection of a management frame for negotiation and measurement related to sensing between the AP and an unassociated station. In an embodiment, it is set to 1 for yes, otherwise it is set to 0. In another embodiment, it may also be set to 0 for yes, and otherwise it is set to 1. A STA may also carry this indication bit in the robust security network extension element (RSNXE) in a probe request frame (Probe Request) to indicate whether protection of a management frame of negotiation and measurement related to sensing between the STA and an unassociated AP is required. The AP and/or the STA save a variable named dot11SensingRequiresPMFActivated in its respective internal management information base (MIB). In a case where a value of the dot11SensingRequiresPMFActivated indicates true, the AP and/or the STA sets the indication bit of the USNM-MFPR to yes, otherwise it is set to no. A driver and/or an application of the AP and/or the STA will set or update the value of the dot11SensingRequiresPMFActivated at startup or when performing inter-device time synchronization.

When the indication bit of an invitation for sensing responding device shown in FIG. 5 indicates yes, and the indication bit for sensing management frame protection required in the robust security network element (RSNE) shown in FIG. 6 indicates no, it indicates that the AP is inviting a sensing responding device to participate in sensing. If the sensing responding device is associated with the AP, the sensing is a non-secure sensing.

When the invitation bit for invitation for sensing responding device shown in FIG. 5 indicates yes, and the indication bit for sensing management frame protection required in the robust security network extension element (RSNXE) shown in FIG. 7 indicates no, it indicates that the AP is inviting a sensing responding device to participate in sensing. If the sensing responding device is not associated with the AP, the sensing is a non-secure sensing.

When the indication bit for invitation for sensing responding device shown in FIG. 5 and the indication bit of management frame protection required (MFPR) in the robust security network element (RSNE) shown in FIG. 6 both indicate yes, it indicates that the AP is inviting a sensing responding device to participate in sensing. If the sensing responding device is associated with the AP, the sensing is a secure sensing.

When the indication bit for invitation for sensing responding device shown in FIG. 5 and the indication bit for sensing management frame protection required in the robust security network extension element (RSNXE) shown in FIG. 7 both indicate yes, it indicates that the AP is inviting a sensing responding device to participate in sensing. If the sensing responding device is not associated with the AP, the sensing is a secure sensing.

In some embodiments, if the first information is used to indicate that the AP is searching for the sensing responding devices of the first type, and/or the first information is used to indicate that the AP supports the STA to participate in the sensing functions of the first type, and the STA supports the sensing functions of the first type, the STA transmits second information to the AP, where the second information includes communication capability information of the STA and sensing capability information of the STA; and the STA receives third information transmitted by the AP, where the third information includes communication capability information of the AP and sensing capability information of the AP.

In some embodiments, the sensing capability information of the STA includes but is not limited to at least one of: the STA supporting the secure sensing function or the STA supporting the non-secure sensing function.

In some embodiments, the sensing capability information of the AP includes but is not limited to at least one of: the AP supporting the secure sensing function, the AP supporting the non-secure sensing function, the AP supporting the STA to participate in the secure sensing function, or the AP supporting the STA to participate in the non-secure sensing function.

In some embodiments, the second information is transmitted via a second frame, and the third information is transmitted via a third frame. The second frame is a sensing session setup request frame, and the third frame is a sensing session setup response frame; or, the second frame is a sensing probe request frame, and the third frame is a sensing probe response frame; or, the second frame is a sensing variant probe request frame, and the third frame is a sensing variant probe response frame.

In some embodiments, in a case that the STA is an unassociated STA with the AP, the third information further includes an unassociation identifier (UID) allocated by the AP to the STA.

In some embodiments, the second frame includes a sensing capability element, and the sensing capability element in the second frame is used to indicate at least one of: whether the STA supports the secure sensing function or whether the STA supports the non-secure sensing function.

In some embodiments, the third frame includes a sensing capability element and an unassociation identifier field. In some embodiments, the sensing capability element in the third frame is used to indicate at least one of: whether the AP supports the secure sensing function, whether the AP supports the non-secure sensing function, whether the AP supports the STA to participate in the secure sensing function, or whether the AP supports the STA to participate in the non-secure sensing function. In some embodiments, the unassociation identifier field is used to indicate the UID allocated by the AP to the STA.

In some embodiments, the third frame further includes a basic service set (BSS) maximum idle time element, and the BSS maximum idle time element is used to instruct the STA to automatically end a sensing session without interacting with the AP for a first time period.

In some implementations, the sensing session setup request frame may be as shown in FIG. 8. For example, a new action frame or an action no acknowledgement (Action No Ack) frame are defined, with an action category (Category) of 4 to indicate that the frame is a public action frame, and a public action subcategory (Public Action Field) of 53 (which may be any value in a range of 51 to 255) to indicate that the frame is a sensing session setup request frame. For another example, a protected sensing session setup request frame is defined as a new action frame or an action no acknowledgment (Action No Ack) frame, with an action category (Category) of 38 to indicate that the frame is a sensing action frame and a sensing action subcategory (Sensing Action Field) of 3 (which may be any value in a range of 0 to 255) to indicate that the frame is a protected sensing session setup request frame. Fields following the sensing action subcategory (Sensing Action Field) are completely consistent with fields following the public action subcategory (Public Action Field) of the aforementioned sensing session setup request frame.

As shown in FIG. 8, the sensing session setup request frame is a frame that is functionally similar to an association request frame (Association Request) or a reassociation request frame (Reassociation Request). For an unassociated STA, since sensing below 1 GHz band and sensing in 45G band are not supported, the unassociated STA does not need to roam and perform quickly association between BSSs. Security negotiation of the unassociated STA is completed through a PASN process. The unassociated STA also does not have data frame interaction, so the sensing session setup request frame indicates a portion of communication-related capability information of the STA.

As shown in FIG. 8, the sensing session setup request frame includes capability information such as: capabilities information field, listening interval field (Listen Interval field), supported rates and BSS membership selectors element, extended supported rates and BSS membership selectors element, power capability element, supported channels element, radio management (RM) enabled capability element, supported operating classes element, high throughput (HT) capabilities element, 20M and 40M bandwidth coexistence element (20/40 BSS Coexistence element), extended capabilities element, DMG capabilities element, enhanced DMG (EDMG) capabilities element, very high throughput (VHT) capabilities element, China directional multi-gigabit (CDMG) capabilities element, supplemental class 2 capabilities element, high efficiency (HE) capabilities element, HE 6G band capabilities element, uplink (UL) Multi-user (MU) power capabilities element, extremely high throughput (EHT) capabilities element.

As shown in FIG. 8, the sensing session setup request frame does not include information such as: smaller than 1 GHz frequency band capability element (SIG Capabilities element), China millimeter-wave multi-gigabit (CMMG) capability element, multi-band capability, fast transition (FT) capability, robust security network association (RSNA) capability, fast initial link setup (FILS) capability, target wake time (TWT) capability, and capabilities used only for data frame transmission (e.g., enhanced distributed channel access (EDCA) parameter element (EDCA Parameter Set element), quality of service (QOS) capability element, QoS traffic capability element, and mirrored stream classification service (MSCS) description information element (MSCS Descriptor element)).

As shown in FIG. 8, the sensing session setup request frame further includes a BSS maximum idle period element (BSS Max Idle Period element) indicating how long the STA lasts without interacting with the AP (i.e., no sensing-related interaction, including sensing measurement setup, sensing measurement, and sensing reporting) will automatically end a sensing session.

As shown in FIG. 8, the sensing session setup request frame further includes a sensing capabilities element indicating specific sensing capabilities information of the STA, including but not limited to: whether it supports a sensing transmitter role, whether it supports a sensing receiver role, whether it supports a sensing initiator role, whether it supports a triggered sensing responder role, whether it supports a non-triggered sensing responder role, supported sensing measurement result types, whether it supports a threshold, whether it supports a sensing by proxy (SBP) requester role, whether it supports an SBP responder role, whether it supports obtaining a combined result report, whether it supports transmitting a combined result report, whether it supports a secure sensing function, and whether it supports a non-secure sensing function. Optionally, the sensing capabilities information may also be indicated in the aforementioned existing capabilities element (e.g., the extended capabilities element).

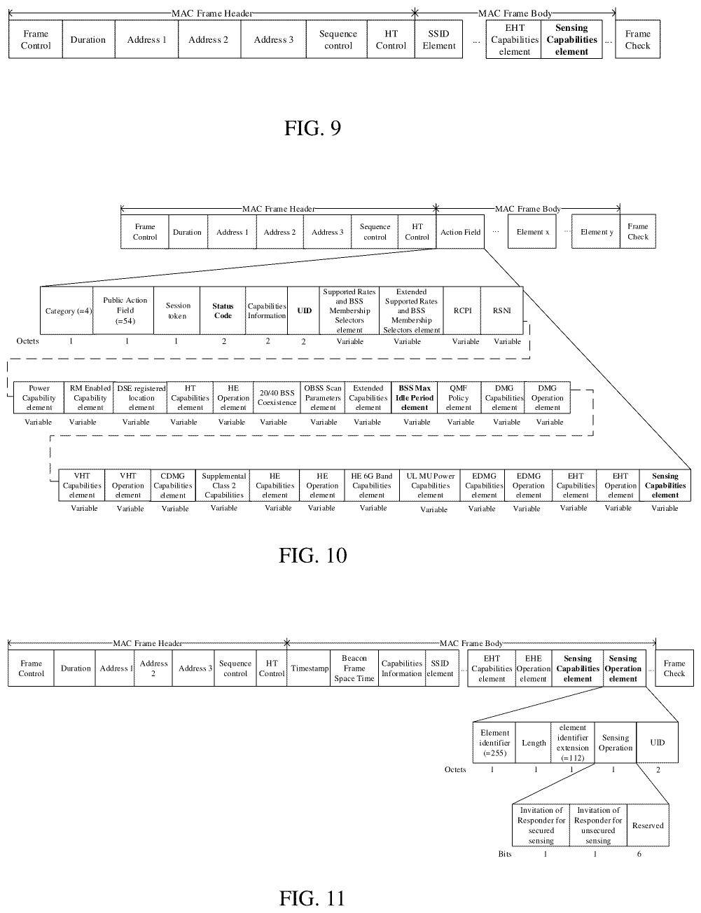

In some implementations, the sensing probe request frame may be as shown in FIG. 9, and the sensing capabilities element is added to an MAC frame body. In addition, the MAC frame body further includes a service set identifier (SSID) element, an extremely high throughput (EHT) capabilities element, etc.

In some implementations, the sensing session setup response frame may be as shown in FIG. 10. For example, the sensing session setup request frame is defined as a new action frame or an action no acknowledgment frame (Action No Ack), with an action category (Category) of 4 to indicate that the frame is a public action frame, and a public action subcategory (Public Action Field) of 54 (any value in a range of 51 to 255 may be used) to indicate that the frame is a sensing session setup response frame. For another example, a protected sensing session setup request frame may be defined as a new action frame or an action no acknowledgment frame (Action No Ack), with an action category (Category) of 38 to indicate that the frame is a sensing action frame, and a sensing action subcategory (Sensing Action Field) of 4 (any value in a range of 0 to 255 may be used) to indicate that the frame is a protected sensing session setup response frame. Fields following the sensing action subcategory (Sensing Action Field) are completely consistent with fields following the public action subcategory (Public Action Field) of the aforementioned sensing session setup response frame.

As shown in FIG. 10, the sensing session setup response frame is a frame that is functionally similar to an association response frame (Association Response) or a reassociation response frame (Reassociation Response). Since an unassociated STA does not support sensing below the 1 GHz band and sensing in the 45G band, the unassociated STA does not need to roam and perform quickly association between BSSs. Security negotiation of the unassociated STA is completed through a PASN process. The unassociated STA also does not have data frame interaction, so the sensing session setup response frame indicates only a portion of communication-related capability information and related operating parameters of the AP.

As shown in FIG. 10, the sensing session setup response frame includes capability information such as: capabilities information field, listening interval field (Listen Interval field), supported rates and BSS membership selectors element, extended supported rates and BSS membership selectors element, received channel power indicator (RCPI) element, received signal-to-noise indicator (RSNI) element, power capability element, supported channels element, RM enabled capability element, dynamic station enablement (DSE) registered location element, HT capabilities element, 20M and 40M bandwidth coexistence element (20/40 BSS Coexistence), overlapping BSS (OBSS) scan parameters element, extended capabilities element, quality-of-service management frame (QMF) policy element, DMG capabilities element, VHT capabilities element, CDMG capabilities element, supplemental class 2 capabilities element (Supplemental Class 2 Capabilities), EDMG capabilities element, HE capabilities element, HE 6G band capabilities element, uplink (UL) multi-user (MU) power capabilities element, EHT capabilities element.

As shown in FIG. 10, the sensing session setup response frame does not include information such as: smaller than 1 GHz, band capabilities, 45G band capability, multi-band capability, FT capability, RSNA capability, FILS capability, TWT capability, and capabilities used only for data frame transmission (e.g., EDCA parameter elements (EDCA Parameter Set element), QoS capability elements, QoS traffic capability element and MSCS description information element (MSCS Descriptor element)).

As shown in FIG. 10, the sensing session setup response frame includes communication-related operation parameters such as: HT operation element, DMG operation element, EDMG operation element, VHT operation element, HE operation element, and EHT operation element.

As shown in FIG. 10, the sensing session setup response frame includes a BSS maximum idle period element (BSS Max Idle Period element) indicating how long the AP lasts without interacting with a corresponding sensing session setup request device (i.e., no sensing-related interaction, including sensing measurement setup, sensing measurement, and sensing reporting) will automatically end a sensing session.

As shown in FIG. 10, the sensing session setup response frame includes a sensing capabilities element indicating specific sensing capabilities information of the AP, including but not limited to: whether it supports a sensing transmitter role, whether it supports a sensing receiver role, whether it supports a sensing initiator role, whether it supports a triggered sensing responder role, whether it supports a non-triggered sensing responder role, supported sensing measurement result types, whether it supports a threshold, whether it supports an SBP requester role, whether it supports an SBP responder role, whether it supports obtaining a combined result report, whether it supports transmitting a combined result report, whether it supports a secure sensing function, whether it supports a non-secure sensing function, whether it supports a station to participate in a secure sensing, and whether it supports a station to participate in a non-secure sensing. Optionally, the sensing capabilities information may also be indicated in the aforementioned existing capabilities element (e.g., the extended capabilities element).

As shown in FIG. 10, the sensing session setup response frame includes a status code field indicating a reason for success and/or failure of sensing session establishment. For example, 0 indicates success (i.e., no error); 131 indicates failure due to the STA not supporting sensing in the 2.4G band; 132 indicates failure due to the STA not supporting sensing in the 5G band; 133 indicates failure due to the STA not supporting sensing in the 6G band; and 134 indicates failure due to the STA not supporting sensing in the 45G/60G band. The value of the status code field is only an example, and it may also be set to any other value in a range of 130 to 65535, as long as a value corresponding to each status code is different from values of other status codes.

As shown in FIG. 10, the sensing session setup response frame includes an unassociation identifier (UID) indicating an identifier allocated to a corresponding sensing session setup request device. The unassociation identifier is used to identify the device in subsequent sensing measurement setup and sensing measurement.

In some implementations, the sensing probe response frame may be as shown in FIG. 11. For example, the above-mentioned sensing capabilities element and sensing operation element may be added to a probe response frame (Probe Response) to indicate that the probe response frame may be a sensing probe response frame. As shown in FIG. 11, an unassociation identifier (UID) field may be added to the sensing operation element to indicate an identifier allocated to a corresponding device that transmits the sensing probe response frame.

In some embodiments, the second information is transmitted via a fourth frame, and the third information is transmitted via a fifth frame; where
the fourth frame is an association request frame, and the fifth frame is an association response frame; or the fourth frame is a reassociation request frame, and the fifth frame is a reassociation response frame.

In some embodiments, in a case where the STA is an associated STA with the AP, the third information further includes an association identifier (AID) allocated by the AP to the STA.

In some embodiments, the fourth frame includes a sensing capability element, and the sensing capability element in the fourth frame is used to indicate at least one of: whether the STA supports the secure sensing function or whether the STA supports the non-secure sensing function.

In some embodiments, the fifth frame includes a sensing capability element and an association identifier field. The sensing capability element in the fifth frame is used to indicate at least one of: whether the AP supports the secure sensing function, whether the AP supports the non-secure sensing function, whether the AP supports the STA to participate in the secure sensing function, or whether the AP supports the STA to participate in the non-secure sensing function. The association identifier field is used to indicate the AID allocated by the AP to the STA.

In some embodiments, the STA receives fourth information transmitted by the AP. In a case where the STA is an unassociated STA with the AP, the fourth information is used to indicate a UID allocated by the AP to the STA; or in a case where the STA is an associated STA with the AP, the fourth information is used to indicate an AID allocated by the AP to the STA.

In some embodiments, the fourth information is transmitted via a sixth frame. In a case where the AP initiates a sensing measurement setup, the sixth frame is a sensing measurement setup request frame; or in a case where the STA initiates a sensing measurement setup, the sixth frame is a sensing measurement setup response frame.

In some embodiments, in a case where the STA is an unassociated STA with the AP and the sixth frame is the sensing measurement setup request frame, an action field of the sixth frame includes a response device information field, the response device information field includes a response device identifier field, and the response device identifier field is used to indicate the UID allocated by the AP to the STA.

In some embodiments, in a case where the STA is an associated STA with the AP and the sixth frame is a sensing measurement setup request frame, an action field of the sixth frame includes a response device information field, the response device information field includes a response device identifier field, and the response device identifier field is used to indicate the AID allocated to the STA by the AP to the STA.

In some embodiments, in a case where the STA is an unassociated STA with the AP and the sixth frame is the sensing measurement setup response frame, an action field of the sixth frame includes an unassociation identifier field, and the unassociation identifier field is used to indicate the UID allocated by the AP to the STA.

In some embodiments, in a case where the STA is an associated STA with the AP and the sixth frame is the sensing measurement setup response frame, an action field of the sixth frame includes an association identifier field, and the association identifier field is used to indicate the AID allocated by the AP to the STA.

In some embodiments, the STA performs preassociation security negotiation (PASN) before establishing a sensing session; or the STA performs PASN after establishing a sensing session.

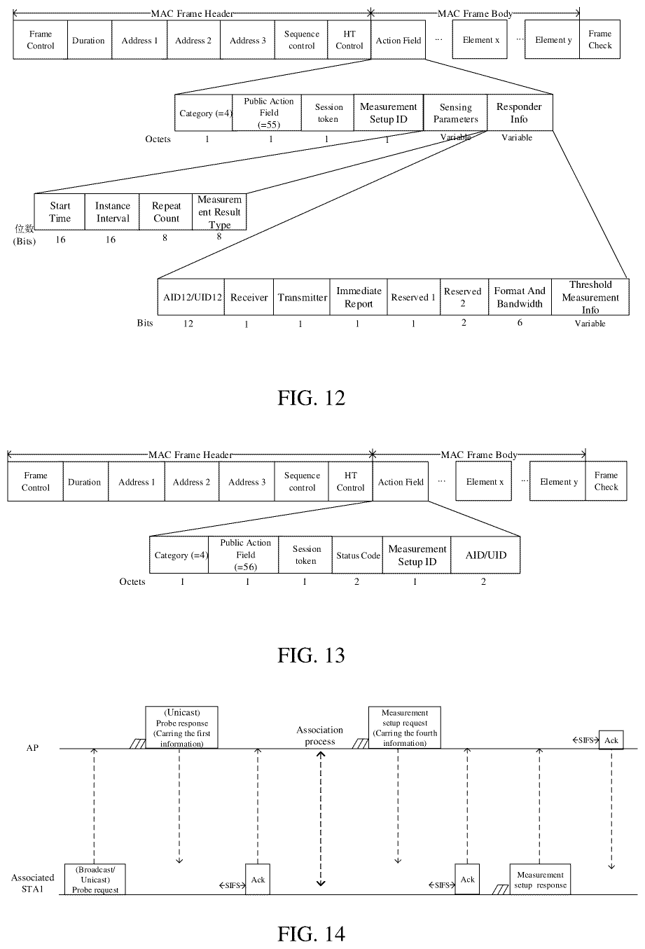

In some implementations, the sensing measurement setup request frame may be as shown in FIG. 12. For measurement setup initiated by an AP, the AP may indicate the UID or the AID allocated to the STA in a transmitted sensing measurement setup request frame.

For example, the sensing measurement setup request frame is defined as a new action frame or an action no acknowledgment frame (Action No Ack), with an action category (Category) of 4 to indicate that the frame is a public action frame, and a public action subcategory (Public Action Field) of 55 (any value in a range of 51 to 255 may be used) to indicate that the frame is a measurement setup request frame. For another example, a protected sensing measurement setup request frame may be defined as a new action frame or an action no acknowledgment frame (Action No Ack), with an action category (Category) of 38 to indicate that the frame is a sensing action frame, and a sensing action subcategory (Sensing Action Field) of 5 (any value in a range of 0 to 255 may be used) to indicate that the frame is a protected sensing measurement setup request frame. Fields following the sensing action subcategory (Sensing Action Field) are completely consistent with fields following the public action subcategory (Public Action Field) of the aforementioned sensing measurement setup request frame.

As shown in FIG. 12, the sensing measurement setup request frame includes a measurement setup identifier (ID) field indicating an identifier of measurement setup.

As shown in FIG. 12, the sensing measurement setup request frame includes a start time field indicating start time of a first measurement instance, which may be set to a partial TSF value of target time, or may be set to an offset value between the target time and current time. TSF may represent a timing synchronization function (TSF), and the partial TSF may represent truncated data of a synchronization time value, e.g., removing the most significant 38 bits and the least significant 10 bits from 64 TSF timer bits.

As shown in FIG. 12, the sensing measurement setup request frame includes an interval between measurement instances (Instance Interval) field indicating interval between two consecutive measurement instances. For example, it may be: in units of 100 milliseconds (ms), 0 for a reserved value, 1 for 100 ms, 2 for 200 ms, and so on. Exemplarily, it may also be: in units of 1 millisecond (ms), 0 for a reserved value, 1 for 1 ms, 2 for 2 ms, 3 for 4 ms, 4 for 8 ms, 5 for 16 ms, 6 for 32 ms, 7 for 64 ms, 8 for 128 ms, and so on.

As shown in FIG. 12, the sensing measurement setup request frame includes a repeat count field indicating the number of planned measurement instances.

As shown in FIG. 12, the sensing measurement setup request frame includes a measurement result type field indicating a type of a measurement result. 0 represents channel state information (CSI), 1 represents beam signal noise ratio (SNR), 2 represents truncated channel impulse response (TCIR) in which channel impulse response (CIR) and channel frequency response (CFR) are Fourier transforms of each other, 3 represents truncated power delay profile (TPDP), 4 represents only amplitude information in the channel state information, 5 represents only phase information in the channel state information, 6 represents angle-of-arrival (AoA), 7 represents angle of departure (AoD), and 8 to 15 are reserved. Herein, these values described in this field are only an exemplary introduction, and they may also be set to other values, as long as a value corresponding to each measurement type is different from values of other measurement types. For example, 2 may represent channel state information, 1 may represent the beam signal noise ratio. For another example, 8 may represent channel state information, 15 may represent the beam signal noise ratio, and so on.

As shown in FIG. 12, the sensing measurement setup request frame includes a response device information (Responder Info) field indicating information of a peer device (a sensing responding device).

As shown in FIG. 12, the sensing measurement setup request frame includes a response device identity (AID/UID) indicating an identifier (ID) of a sensing responding device, which is an association identifier (AID) for an associated STA or an unassociation identifier (UID) for an unassociated STA. The UID is allocated by the AP, and an allocated space is consistent with the AID. 0 is the AID of the associated AP.

As shown in FIG. 12, the sensing measurement setup request frame includes a sensing signal receiving device (Receiver) indicating whether a sensing responding device (Responder) participates in measurement as the sensing signal receiving device (Receiver). In an embodiment, it is set to 1 for yes, otherwise it is set to 0. In another embodiment, it may also be set to 0 for yes, otherwise it is set to 1.

As shown in FIG. 12, the sensing measurement setup request frame includes a sensing signal transmitting device (Transmitter) indicating whether a sensing responding device (Responder) participates in measurement as the sensing signal transmitting device (Transmitter). In an embodiment, it is set to 1 for yes, otherwise it is set to 0. In another embodiment, it may also be set to 0 for yes, otherwise it is set to 1.

As shown in FIG. 12, the sensing measurement setup request frame includes a result immediate report field indicating whether a measurement result need to be reported immediately in a case where the sensing responding device (Responder) participates in the measurement as the sensing signal receiving device (Receiver). This field is a reserved field in a case where the sensing responding device (Responder) participates in the measurement as a sensing signal transmitting device (Transmitter).

As shown in FIG. 12, the sensing measurement setup request frame includes a format and bandwidth field indicating format and bandwidth information of a physical layer protocol data unit (PPDU) used in sensing measurement.

As shown in FIG. 12, the sensing measurement setup request frame includes measurement threshold information (Threshold Measurement Info) indicating setup information of measurement based on threshold.

In some implementations, the sensing measurement setup response frame may be as shown in FIG. 13. For measurement setup initiated by a STA, an AP may indicate a UID or an AID allocated to the STA in a transmitted sensing measurement setup response frame.

For example, the sensing measurement setup response frame is defined as a new action frame or an action no acknowledgment frame (Action No Ack), with an action category (Category) of 4 to indicate that the frame is a public action frame and a public action subcategory (Public Action Field) of 56 (any value in a range of 51 to 255 may be used) to indicate that the frame is a measurement setup response frame.

For another example, a protected sensing measurement setup response frame may be defined as a new action frame or an action no acknowledgment frame (Action No Ack), with an action category (Category) of 38 to indicate that the frame is a sensing action frame, and a sensing action subcategory (Sensing Action Field) of 6 (any value in a range of 0 to 255 may be used) to indicate that the frame is a protected sensing measurement setup response frame. Fields following the sensing action subcategory (Sensing Action Field) are completely consistent with fields following the public action subcategory (Public Action Field) of the aforementioned sensing measurement setup response frame.

As shown in FIG. 13, the sensing measurement setup response frame includes a status code: 0 indicates success (i.e., a request is accepted), and 1 indicates failure (i.e., a request is rejected without a reason). Values described in this field are only an exemplary introduction, and they may also be set to other values, as long as a value corresponding to each status code is different from values of other status codes.

As shown in FIG. 13, the sensing measurement setup response frame includes a measurement setup identifier (ID) field indicating an identifier of a measurement setup to be set up. This field exists in a case that the status code field indicates success, otherwise it does not exist.

As shown in FIG. 13, the sensing measurement setup response frame includes an association identifier (AID)/unassociation identifier (UID) indicating an ID allocated to a sensing initiating device (Initiator), which is the association identifier (AID) for an associated STA, or the unassociation identifier (UID) for an unassociated STA. The UID is allocated by the AP, and an allocated space is consistent with the AID. 0 is the AID of the associated AP.

In some embodiments, for an associated station (STA) with an AP, the STA and the AP establish a sensing session in an association process, and the STA carries its own communication capability information and sensing capability information in a transmitted association request frame (Association Request) and/or reassociation request frame (Reassociation Request), and the AP carries its own communication capability information and sensing capability information in a transmitted association response frame (Association Response) and/or reassociation response frame (Reassociation Response), which also indicates an AID allocated to the STA. For example, as shown in FIG. 14, an associated STA1 transmits a probe request frame via broadcast or unicast, and an AP transmits a probe response frame to the STA1 via unicast. The probe response frame carries first information, and the first information is used to indicate that the AP is searching for a secure sensing responding device and/or a non-secure sensing responding device, and/or, the first information is used to indicate that the AP supports the STA to participate in a secure sensing function and/or a non-secure sensing function. In a case where STA1 supports the sensing function indicated by the AP through the first information and the STA1 is willing to participate in a sensing measurement: the STA1 feeds back an acknowledgement (ACK) to the AP; an association process is performed between the AP and the STA1; the AP transmits a measurement setup request frame to the STA1, where the measurement setup request frame carries an AID allocated to STA1 (for example, the measurement setup request frame carries fourth information, and the fourth information is used to indicate the AID allocated to the STA1); the STA1 feeds back an ACK to the AP; the STA1 transmits a measurement setup response frame to the AP; and the AP feeds back an ACK to the STA1, thereby completing a sensing measurement setup.

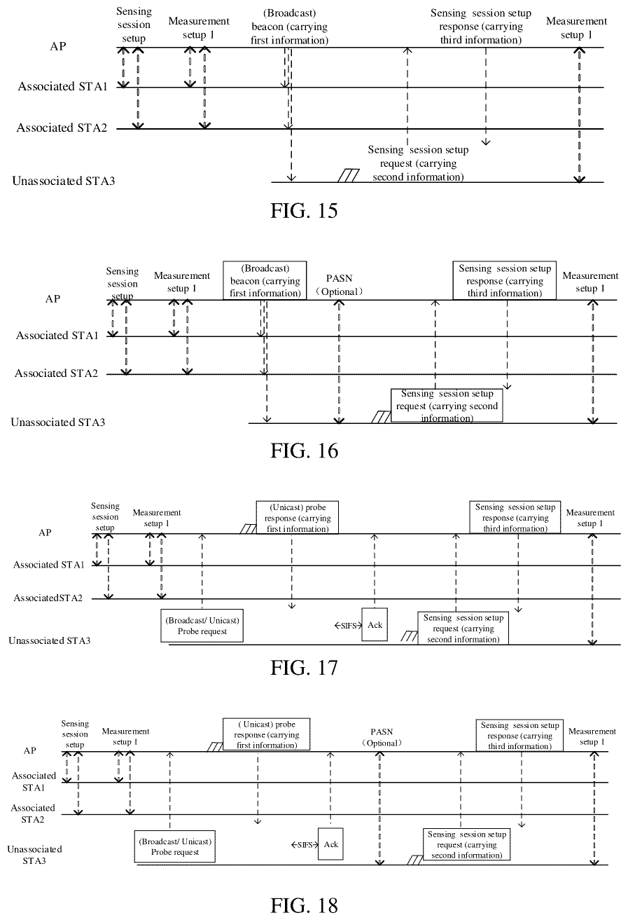

In some embodiments, for an unassociated station (STA) with an AP, as shown in FIG. 15, STA3 receives a beacon frame (Beacon) transmitted by an AP, which carries first information. The first information is used to indicate that the AP is searching for a secure sensing responding device and/or a non-secure sensing responding device, and/or, the first information is used to indicate that the AP supports the STA to participate in a secure sensing function and/or a non-secure sensing function. In a case where the STA3 supports the sensing function indicated by the AP through the first information and the STA3 is willing to participate in a sensing measurement: the STA3 transmits a sensing session setup request frame carrying second information, where the second information includes communication capability information of the STA3 and sensing capability information of the STA3, and the sensing capability information of the STA3 includes at least one of STA3 supporting the secure sensing function or STA3 supporting the non-secure sensing function; the AP carries third information in a transmitted sensing session setup response frame, where the third information includes communication capability information of the AP and sensing capability information of the AP, and the sensing capability information of the AP includes at least one of: the AP supporting the secure sensing function, the AP supporting the non-secure sensing functions, the AP supporting the STA to participate in the secure sensing function, or the AP supporting the STA to participate in the non-secure sensing function. Optionally, the AP may indicate a UID allocated to the STA3 in a sensing session setup response frame; for example, the third information includes the UID allocated to the STA3 by the AP. Optionally, as shown in FIG. 16, the STA3 may perform preassociation security negotiation (PASN) before or after establishing a sensing session. Optionally, for a measurement setup initiated by the AP, the AP may indicate the UID allocated to the STA3 in a transmitted sensing measurement setup request frame, and for example, fourth information carried in the sensing measurement setup request frame is used to indicate the UID allocated to the STA3; for a measurement setup initiated by the STA3, the AP may indicate the UID allocated to the STA3 in a transmitted sensing measurement setup response frame, and for example, fourth information carried in the sensing measurement setup response frame is used to indicate the UID allocated to the STA3. It should be noted that the beacon frame in FIGS. 15 and 16 may also be replaced by a DMG beacon frame.

In some embodiments, for an unassociated station (STA) with an AP, as shown in FIG. 17, STA3 receives a probe response frame transmitted by the AP, which carries first information. The first information is used to indicate that the AP is searching for a secure sensing responding device and/or a non-secure sensing responding device, and/or, the first information is used to indicate that the AP supports the STA to participate in the secure sensing function and/or the non-secure sensing function. In a case where the STA3 supports the sensing function indicated by the AP through the first information and the STA3 is willing to participate in a sensing measurement: STA3 transmits a sensing session setup request frame carrying second information, the second information includes communication capability information of the STA3 and sensing capability information of the STA3, and the sensing capability information of the STA3 includes at least one of the STA3 supporting a secure sensing function or the STA3 supporting a non-secure sensing function; the AP carries third information in a transmitted sensing session setup response frame, the third information includes communication capability information of the AP and sensing capability information of the AP, and the sensing capability information of the AP includes at least one of: the AP supporting a secure sensing function, the AP supporting a non-secure sensing function, the AP supporting the STA to participate in a secure sensing function, or the AP supporting the STA to participate in a non-secure sensing function. Optionally, the AP may indicate a UID allocated to the STA3 in the sensing session setup response frame; for example, the third information includes the UID allocated to the STA3 by the AP. Optionally, as shown in FIG. 18, the STA3 may perform preassociation security negotiation (PASN) before or after establishing a sensing session. Optionally, for a measurement setup initiated by the AP, the AP may indicate the UID allocated to the STA3 in a transmitted sensing measurement setup request frame, and for example, fourth information carried in the sensing measurement setup request frame is used to indicate the UID allocated to the STA3; for a measurement setup initiated by the STA3, the AP may indicate the UID allocated to the STA3 in a transmitted sensing measurement setup response frame, and for example, fourth information carried in the sensing measurement setup response frame is used to indicate the UID allocated to the STA3.

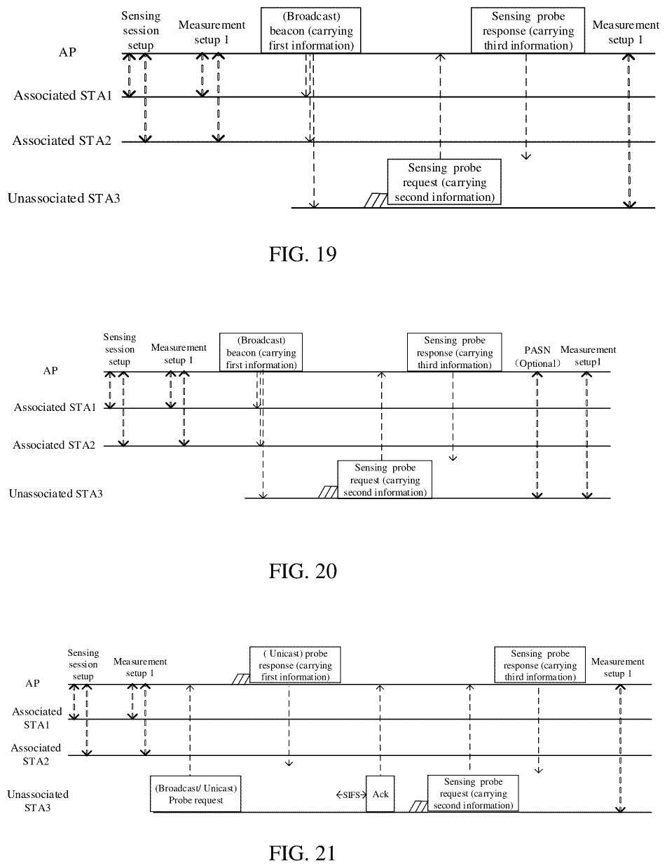

In some embodiments, for an unassociated station (STA) with an AP, as shown in FIG. 19, STA3 receives a beacon frame (Beacon) transmitted by an AP, which carries first information. The first information is used to indicate that the AP is searching for a secure sensing responding device and/or a non-secure sensing responding device, and/or, the first information is used to indicate that the AP supports the STA to participate in a secure sensing function and/or a non-secure sensing function. In a case where the STA3 supports the sensing function indicated by the AP through the first information and the STA3 is willing to participate in a sensing measurement: the STA3 transmits a sensing probe request frame carrying second information, the second information includes communication capability information of the STA3 and sensing capability information of the STA3, and the sensing capability information of STA3 includes at least one of STA3 supporting a secure sensing function or STA3 supporting a non-secure sensing function; the AP carries third information in a transmitted sensing probe response frame, the third information includes communication capability information of the AP and sensing capability information of the AP, and the sensing capability information of the AP includes at least one of: the AP supporting a secure sensing function, the AP supporting a non-secure sensing function, the AP supporting the STA to participate in a secure sensing function, or the AP supporting the STA to participate in a non-secure sensing function. Optionally, the AP may indicate a UID allocated to the STA3 in a sensing probe response frame, and for example, the third information includes the UID allocated to the STA3 by the AP. Optionally, as shown in FIG. 20, the STA3 may perform preassociation security negotiation (PASN) before or after establishing a sensing session. Optionally, for the measurement setup initiated by the AP, the AP may indicate the UID allocated to the STA3 in a transmitted sensing measurement setup request frame, and for example, fourth information carried in the sensing measurement setup request frame is used to indicate the UID allocated to the STA3; for the measurement setup initiated by the STA3, the AP may indicate the UID allocated to the STA3 in a transmitted sensing measurement setup response frame, and fourth information carried in the sensing measurement setup response frame is used to indicate the UID allocated to the STA3. It should be noted that the beacon frame in FIGS. 19 and 20 may also be replaced by a DMG beacon frame, the sensing probe request frame in FIGS. 19 and 20 may also be replaced by a sensing variant probe request frame (Sensing variant Probe Request), and the sensing probe response frame may also be replaced by a sensing variant probe response frame (Sensing variant Probe Response).

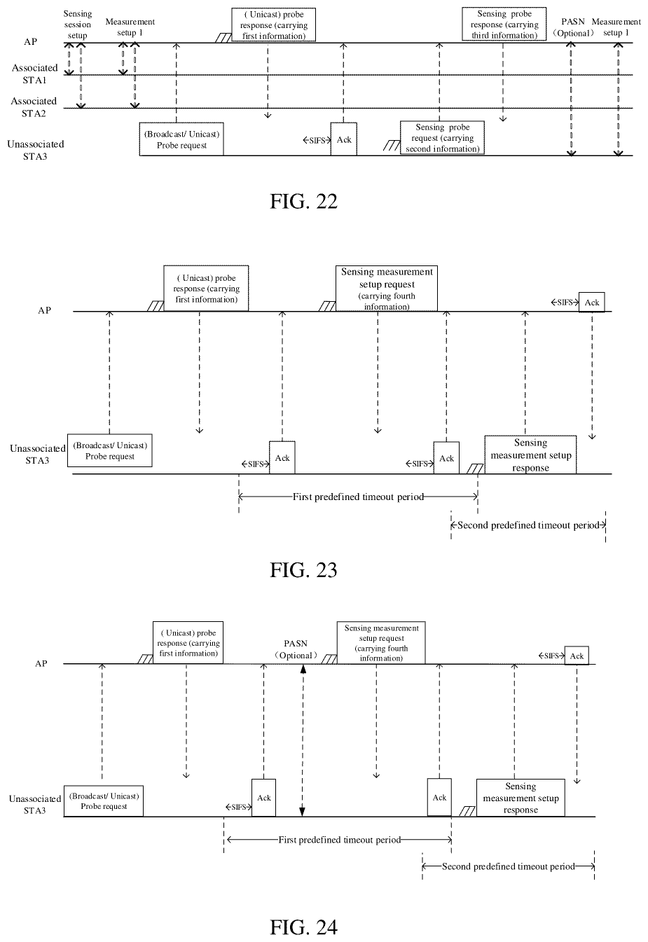

In some embodiments, for an unassociated station (STA) with an AP, as shown in FIG. 21, STA3 receives a probe response frame transmitted by the AP, which carries first information. The first information is used to indicate that the AP is searching for a secure sensing responding device and/or a non-secure sensing responding device, and/or, the first information is used to indicate that the AP supports the STA to participate in a secure sensing function and/or a non-secure sensing function. In a case where the STA3 supports the sensing function indicated by the AP through the first information and the STA3 is willing to participate in a sensing measurement: the STA3 transmits a sensing probe request frame carrying second information, the second information includes communication capability information of the STA3 and sensing capability information of the STA3, and the sensing capability information of the STA3 includes at least one of the STA3 supporting a secure sensing function or the STA3 supporting a non-secure sensing function; the AP carries third information in a transmitted sensing probe response frame, the third information includes communication capability information of the AP and sensing capability information of the AP, and the sensing capability information of the AP includes at least one of: the AP supporting a secure sensing function, the AP supporting a non-secure sensing function, the AP supporting the STA to participate in a secure sensing function, or the AP supporting the STA to participate in a non-secure sensing function. Optionally, the AP may indicate a UID allocated to the STA3 in the sensing probe response frame, and for example, the third information includes the UID allocated to the STA3 by the AP. Optionally, as shown in FIG. 22, the STA3 may perform preassociation security negotiation (PASN) before or after establishing a sensing session. Optionally, for a measurement setup initiated by the AP, the AP may indicate the UID allocated to the STA3 in a transmitted sensing measurement setup request frame, and for example, fourth information carried in the sensing measurement setup request frame is used to indicate the UID allocated to the STA3; for a measurement setup initiated by the STA3, the AP may indicate the UID allocated to the STA3 in a transmitted sensing measurement setup response frame, and for example, the fourth information carried in the sensing measurement setup response frame is used to indicate the UID allocated to the STA3. It should be noted that the sensing probe request frame in FIGS. 21 and 22 may also be replaced by a sensing variant probe request frame (Sensing variant Probe Request), and the sensing probe response frame may also be replaced by a sensing variant probe response frame (Sensing variant Probe Response).

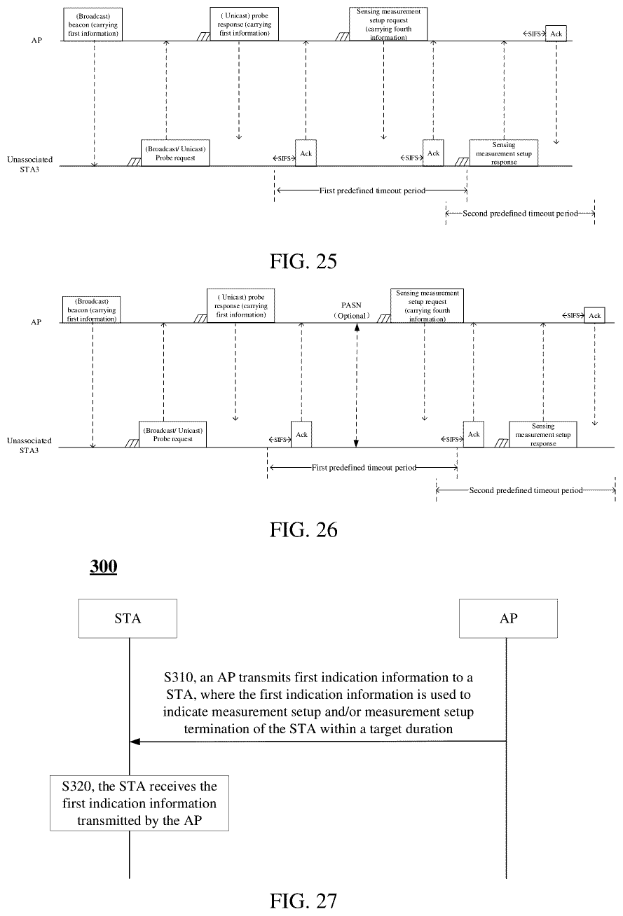

In some embodiments, for an unassociated station (STA) with an AP, as shown in FIGS. 23, 24, 25 and 26, the AP will initiate a measurement setup to the STA3 within a first predefined timeout period after feeding back a probe response frame to the STA3. If the STA3 is willing to participate in the measurement setup initiated by the AP, the STA3 needs to stay on a channel used by the AP. Optionally, after the STA3 receives the probe response frame from the AP, it immediately performs preassociation security negotiation (PASN). The AP will initiate a measurement setup to STA3 within the first predefined timeout period after the STA3 completes the preassociation security negotiation (PASN). The STA3 needs to feed back a measurement setup response frame within a second predefined timeout period after receiving a measurement setup request, otherwise the measurement setup fails. Optionally, after receiving the probe response frame from the AP, the STA3 may also actively initiate another measurement setup, and the AP may still initiate the aforementioned measurement setup to the STA3 within a predefined timeout period. Optionally, the STA3 performs preassociation security negotiation (PASN) immediately after receiving the probe response frame from the AP. After the STA3 completes the preassociation security negotiation (PASN), the STA3 may also actively initiate another measurement setup, and the AP may still initiate the aforementioned measurement setup to the STA3 within the first predefined timeout period.

In some embodiments, for an unassociated station (STA) with the AP, as shown in FIGS. 23, 24, 25 and 26, for the measurement setup initiated by the AP, the AP may indicate the UID allocated to the STA3 in the transmitted sensing measurement setup request frame (Sensing Measurement Setup Request), and for example, the fourth information carried in the sensing measurement setup request frame is used to indicate the UID allocated to the STA3.

In some embodiments, for an unassociated station (STA) with the AP, for the measurement setup initiated by the STA3, the AP may indicate the UID allocated to the STA3 in the transmitted sensing measurement setup response frame (Sensing Measurement Setup Response), and for example, the fourth information carried in the sensing measurement setup response frame is used to indicate the UID allocated to the STA3. Specific reference may be made to FIGS. 23, 24, 25, and 26, which will not be repeated here. In addition, FIGS. 23, 24, 25, and 26 are examples of the unassociated station (STA3), and the same applies for an associated station.

Therefore, in embodiments of the present application, the AP may indicate, through the first information, whether the AP is searching for the secure sensing responding device and/or the non-secure sensing responding device, and/or the AP may indicate, through the first information, whether the AP supports the STA to participate in the secure sensing function and/or the non-secure sensing function, so that the STA which has received the first information may participate in the sensing session based on the indication of the AP and establish the sensing session.

FIG. 27 is a schematic interaction flow chart of a method for wireless communication 300 in accordance with embodiments of the present application. As shown in FIG. 27, the method for wireless communication 300 may include at least part of the following content:
in S310, an AP transmits first indication information to a STA, where the first indication information is used to indicate new measurement setup and/or measurement setup termination with the STA within a target duration; and
in S320, the STA receives the first indication information transmitted by the AP.

In the embodiments of the present application, the AP may indicate the new measurement setup and/or measurement setup termination with the STA within the target duration by using the first indication information, where the target duration is a period of time in the future. That is, the AP may inform the STA in advance of future measurement setup and/or measurement setup termination, thereby ensuring that the new measurement setup and/or measurement setup termination of the AP within the target duration may be performed smoothly.

In some embodiments, the STA is an associated STA with the AP, or the STA is an unassociated STA with the AP.

In some embodiments, since a station, especially an unassociated STA with an AP, may enter a power saving mode or leave coverage of a BSS, the AP may not be able to successfully initiate measurement setup and/or measurement setup termination with the station. Furthermore, since an unassociated station with the AP generally remains available in a measurement instance in which it participates, the AP may inform the station in advance of future measurement setup and/or measurement setup termination in the measurement instance in which it participates.

In some embodiments, the target duration is a predefined timeout period, or the target duration is a timeout period indicated by the AP.

In some embodiments, the STA transmits first capability information to the AP, where the first capability information is used to indicate whether the STA supports measurement that does not need polling.

For example, the STA indicates the first capability information in an extended capability element and/or a sensing capability element.

In some embodiments, in a case where the STA does not support measurement that does not need polling, the AP does not establish a measurement setup with the STA, or the AP indicates to poll the STA in a polling phase in a process of establishing a measurement setup with the STA.

In some embodiments, in a case where the STA supports measurement that does not need polling, the AP indicates to poll the STA in the polling phase in a process of establishing a measurement setup with the STA, or the AP indicates not to poll the STA in the polling phase in the process of establishing the measurement setup with the STA.

In some embodiments, the STA receives second indication information transmitted by the AP, where the second indication information is used to indicate whether the AP polls the STA in the polling phase.

In some embodiments, the second indication information is transmitted via a measurement setup request frame; where the measurement setup request frame includes a field for whether to be polled, and the field for whether to be polled is used to indicate whether the STA will be polled in a polling phase of a trigger based measurement instance.

In some embodiments, the measurement setup request frame further includes a field for whether there are more exchanges; where the field for whether there are more exchanges is used to indicate whether the AP intends to establish more measurement setups and/or intends to terminate one or more existing measurement setups with the STA within the target duration; or, the field for whether there are more exchanges includes a first subfield and a second subfield, the first subfield is used to indicate whether the AP intends to establish more measurement setups with the STA within the target duration, and the second subfield is used to indicate whether the AP intends to terminate one or more existing measurement setups with the STA within the target duration.

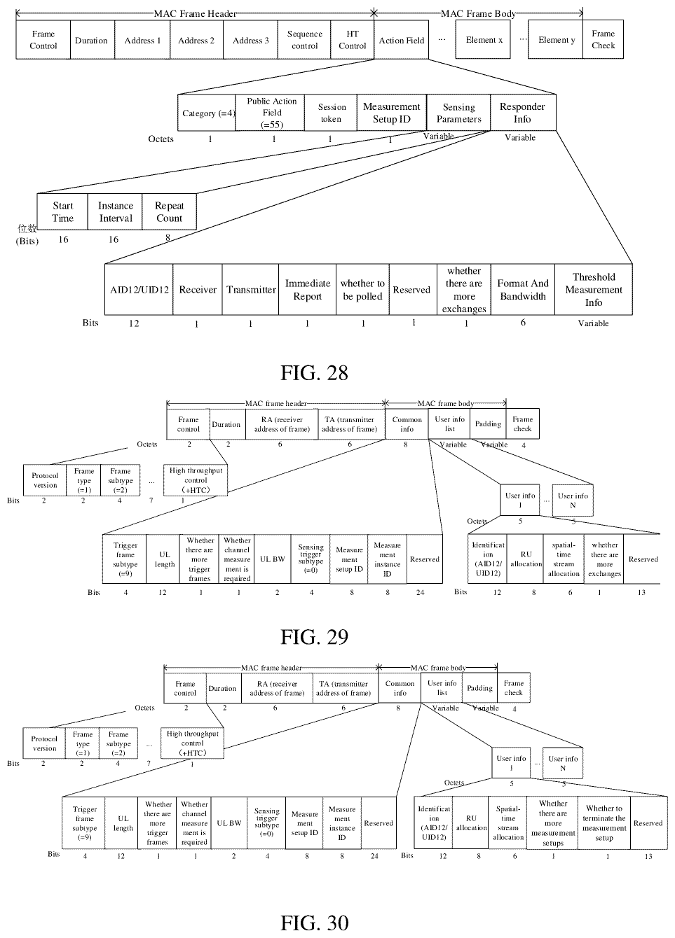

For example, the measurement setup request frame may be as shown in FIG. 28. A MAC frame body of the measurement setup request frame includes an action field, the action field includes a response device information field, and the response device information field includes a field for whether to be polled and a field for whether there are more exchanges.

In the measurement setup request frame as shown in FIG. 28, the field for whether to be polled (Polling field) indicates whether the STA will be polled in a polling phase of a trigger based measurement instance. Here, the STA is a sensing responding device. For example, it is set to 1 for yes, otherwise it is set to 0. For another example, it is set to 0 for yes, otherwise it is set to 1.

In the measurement setup request frame as shown in FIG. 28, the field for whether there are more exchanges (More Exchange field) indicates whether the AP will establish more measurement setups and/or terminate the existing measurement setups with the STA within the target duration (i.e., a future timeout period). Here, the STA is a sensing responding device. For example, it is set to 1 for yes, otherwise it is set to 0. For another example, it is set to 0 for yes, otherwise it is set to 1.

In some embodiments, for a trigger based measurement process (or referred to as measurement instance, TB Measurement Instance), generally, in a first phase, i.e. in the polling phase, an AP transmits a polling trigger frame to probe whether a sensing participating device is available. However, the polling phase may not always exist; for example, all stations participating in the trigger based measurement process support measurement that does not need polling (for example, all stations are associated stations with the AP and do not enter a power saving mode). A station supporting measurement that does not need polling indicates first capability information (capability of supporting measurement that does not need polling) when exchanging sensing capability information with an AP, for example, indicates the first capability information in an extended capability element and/or a sensing capability element. Optionally, when the AP performs measurement setup with the STA, the AP determines whether to poll the STA in the polling phase. For example, the AP transmits the second indication information to the STA in the measurement setup request frame, as shown in FIG. 28. For a station that does not support measurement that does not need polling, the AP may not establish the measurement setup with the station. If the AP establishes the measurement setup with the station, the AP needs to poll the station in the polling phase. For a station that supports measurement that does not need polling, the AP may or may not poll the station in the polling phase, as long as it is consistent with the indication of the measurement setup.

In some embodiments, the first indication information is transmitted by the AP in a polling phase. In some implementations, the first indication information is transmitted via a polling trigger frame. Optionally, the AP indicates that the STA will be polled in the polling phase when performing measurement setup with the STA; or, the AP defaults to polling the STA in the polling phase when performing measurement setup with the STA. The STA is an unassociated STA with the AP.

In some embodiments, the polling trigger frame includes a field for whether there are more exchanges, where the field for whether there are more exchanges is used to indicate whether the AP intends to establish more measurement setups and/or intends to terminate one or more existing measurement setups with the STA within the target duration.

For example, as shown in FIG. 29, a MAC frame body of a polling trigger frame includes a user information list field, and a user information field in the user information list field includes a field for whether there are more exchanges, and the field for whether there are more exchanges is used to indicate whether the AP intends to establish more measurement setups and/or intends to terminate one or more existing measurement setups with the STA within the target duration. For example, it is set to 1 for yes, otherwise it is set to 0. For another example, it is set to 0 for yes, otherwise it is set to 1.

In some embodiments, the polling trigger frame includes a field for whether there are more exchanges, where the field for whether there are more exchanges includes a first subfield and a second subfield, the first subfield is used to indicate whether the AP intends to establish more measurement setups with the STA within the target duration, and the second subfield is used to indicate whether the AP intends to terminate one or more existing measurement setups with the STA within the target duration.

In some embodiments, the polling trigger frame includes a field for whether there are more measurement setups and a field for whether to terminate a measurement setup. Here, the field for whether there are more measurement setups is used to indicate whether the AP intends to establish more measurement setups with the STA within the target duration, and the field for whether to terminate the measurement setup is used to indicate whether the AP intends to terminate a measurement setup corresponding to a measurement setup identifier in common information with the STA within the target duration.

For example, as shown in FIG. 30, a MAC frame body of a polling trigger frame includes a user information list field, and a user information field in the user information list field includes a field for whether there are more measurement setups and a field for whether to terminate a measurement setup.

As shown in FIG. 30, the field for whether there are more measurement setups is used to indicate whether the AP establishes more measurement setups with the STA within the target duration; for example, it is set to 1 for yes, otherwise it is set to 0. For another example, it is set to 0 for yes, otherwise it is set to 1.

As shown in FIG. 30, the field for whether to terminate the measurement setup is used to indicate whether the AP terminates a measurement setup corresponding to a measurement setup identifier in common information with the STA within the target duration. For example, it is set to 1 for yes, otherwise it is set to 0. For another example, it is set to 0 for yes, otherwise it is set to 1.

In some embodiments, the AP may inform one or more stations (stations that need to be polled, including associated stations with the AP and/or unassociated stations with the AP) in the polling phase in advance of measurement setup and/or measurement setup termination within the target duration (i.e., a future timeout period), where structure of the polling trigger frame may be as shown in FIG. 29 or 30. For this reason, the polling phase needs to exist, so it is specified that: for an unassociated station with the AP, the AP always indicates that the station will be polled in the polling phase when the AP performs measurement setup with the station; or, the AP defaults to polling the station in the polling phase when the AP performs measurement setups with the station. In the polling phase, a station that is not polled directly drops the polling frame.

In some embodiments, the first indication information is transmitted by the AP in one of the following phases:
a polling phase, an uplink sounding phase, a downlink sounding phase.

In some embodiments, if the polling phase exists, the first indication information is transmitted via a polling trigger frame (as shown in FIG. 29 or 30); and/or, if the polling phase does not exist, the uplink downlink sounding phase exists and the STA participates in uplink downlink sounding, the first indication information is transmitted via a sounding trigger frame; and/or, if the polling phase does not exist, the downlink sounding phase exists and the STA participates in downlink sounding, the first indication information is transmitted via a sounding announcement frame.

In some embodiments, in a case where the AP indicates that the STA performs a threshold based reporting, the first indication information is transmitted via a threshold check polling frame.

In some embodiments, the sounding trigger frame includes a field for whether there are more measurement setups, where the field for whether there are more measurement setups is used to indicate whether the AP intends to establish more measurement setups with the STA within the target duration.

For example, as shown in FIG. 31, A MAC frame body of the sounding trigger frame includes a user information list field, and a user information field in the user information list field includes a field for whether there are more exchanges, and the field for whether there are more exchanges is used to indicate whether the AP intends to establish more measurement setups and/or intends to terminate one or more existing measurement setups with the STA within the target duration. For example, it is set to 1 for yes, otherwise it is set to 0. For another example, it is set to 0 for yes, otherwise it is set to 1.

In some embodiments, the sounding trigger frame includes a field for whether there are more exchanges, and the field for whether there are more exchanges includes a first subfield and a second subfield. The first subfield is used to indicate whether the AP intends to establish more measurement setups with the STA within the target duration, and the second subfield is used to indicate whether the AP intends to terminate one or more existing measurement setups with the STA within the target duration.

In some embodiments, the sounding announcement frame includes a field for whether it is used for sensing and field for whether there are more measurement setups;
the field for whether it is used for sensing is used to indicate whether the sounding announcement frame is a sounding announcement frame for sensing, and the field for whether there are more measurement setups is used to indicate whether the AP intends to establish more measurement setups with the STA within the target duration.

In some embodiments, the sounding announcement frame includes a field for whether it is used for sensing and a field for whether there are more exchanges. Here, the field for whether it is used for sensing is used to indicate whether the sounding announcement frame is a sounding announcement frame for sensing; and the field for whether there are more exchanges includes a first subfield and a second subfield, the first subfield is used to indicate whether the AP intends to establish more measurement setups with the STA within the target duration, and the second subfield is used to indicate whether the AP intends to terminate one or more existing measurement setups with the STA within the target duration.

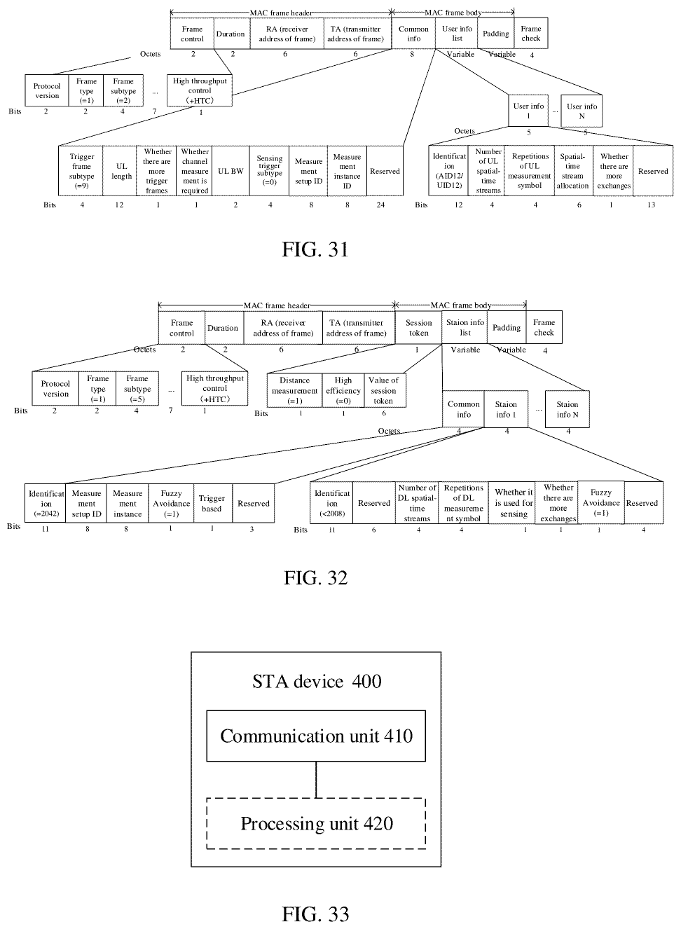

For example, as shown in FIG. 32, a MAC frame body of a sounding announcement frame includes a station information list field, and a station information field in the station information list field includes a field for whether it is used for sensing and a field for whether there are more exchanges.

As shown in FIG. 32, the field for whether it is used for sensing is used to indicate whether the sounding announcement frame is a sounding announcement frame for sensing. For example, it is set to 1 for yes, otherwise it is set to 0. For another example, it is set to 0 for yes, otherwise it is set to 1.

As shown in FIG. 32, the field for whether there are more exchanges is used to indicate whether the AP intends to establish more measurement setups and/or intends to terminate one or more existing measurement setups with the STA within the target duration. For example, it is set to 1 for yes, otherwise it is set to 0. For another example, it is set to 0 for yes, otherwise it is set to 1.

In some embodiments, since at least one of a polling phase, an uplink sounding phase, or a downlink sounding phase exists in a trigger based measurement instance, one or more stations may be informed in advance of future measurement setup and/or measurement setup termination in any of the three: a polling trigger frame (TF Poll, as shown in FIG. 29 or 30) used in a polling phase, a sounding trigger frame (TF Sounding, as shown in FIG. 31) used for uplink sounding, and a sounding announcement frame (NDPA, as shown in FIG. 32) used for downlink sounding. For example, if the polling phase exists, it is informed in the polling trigger frame. If the polling phase does not exist, the uplink sounding phase exists and the station participates in the uplink sounding, it is informed in the sounding trigger frame. If the polling phase does not exist, the downlink sounding phase exists and the station participates in the downlink sounding, it is informed in the sounding announcement frame. Optionally, in a trigger based measurement instance, if the AP requires the station to perform a threshold based reporting, the AP may also indicate to the station in a threshold check polling frame that more measurement setups will be established and/or existing measurement setups will be terminated within a target duration (i.e., a future timeout period).

In some embodiments, in a trigger based measurement instance and/or in a non-trigger based measurement instance, the first indication information is transmitted via a sensing reporting trigger frame, and/or, the first indication information is transmitted via a sensing reporting frame.

In some embodiments, in a case where the AP needs to request the STA to transmit a sensing reporting, the first indication information is transmitted via the sensing reporting trigger frame; and/or, in a case where the AP transmits a sensing reporting to the STA, the first indication information is transmitted via the sensing reporting frame.

For example, in a trigger based measurement instance and/or in a non-trigger based measurement instance, if the AP needs to request the STA to transmit a sensing reporting, the AP may also indicate to the STA in the sensing reporting trigger frame that more measurement setups will be established and/or the existing measurement setups will be terminated within the target duration (i.e., a future timeout period).

For example, in a trigger based measurement instance and/or in a non-trigger based measurement instance, if the AP transmits a sensing reporting to the STA, the AP may also indicate to the STA in the sensing reporting frame that more measurement setups will be established and/or the existing measurement setups will be terminated within the target duration (i.e., a future timeout period).

In some implementations, the sensing reporting trigger frame includes at least a field for whether there are more exchanges, where the field for whether there are more exchanges is used to indicate whether the AP intends to establish more measurement setups and/or intends to terminate one or more existing measurement setups with the STA within the target duration.

In some implementations, the sensing reporting trigger frame includes at least a field for whether there are more exchanges, where the field for whether there are more exchanges includes a first subfield and a second subfield, the first subfield is used to indicate whether the AP intends to establish more measurement setups with the STA within the target duration, and the second subfield is used to indicate whether the AP intends to terminate one or more existing measurement setups with the STA within the target duration.

In some implementations, the sensing reporting frame includes at least a field for whether there are more exchanges, where the field for whether there are more exchanges is used to indicate whether the AP intends to establish more measurement setups and/or intends to terminate one or more existing measurement setups with the STA within the target duration.

In some implementations, the sensing reporting frame includes at least a field for whether there are more exchanges, where the field for whether there are more exchanges includes a first subfield and a second subfield, the first subfield is used to indicate whether the AP intends to establish more measurement setups with the STA within the target duration, and the second subfield is used to indicate whether the AP intends to terminate one or more existing measurement setups with the STA within the target duration.

In some embodiments, the first indication information is transmitted via a measurement setup request frame transmitted by the AP for establishing a target measurement setup with the STA.

In some embodiments, when establishing a certain measurement setup with the STA, the AP may further inform the STA in advance of future measurement setup and/or measurement setup termination, that is, the AP indicates to the STA in the measurement setup request frame that more measurement setups will be established and/or the existing measurement setups will be terminated within a future timeout period. For example, when the AP establishes measurement setup 1, it informs the STA that measurement setup 2 will be established within the next second. For another example, when the AP establishes measurement setup 3, it informs the STA that measurement setup 1 and measurement setup 2 will be terminated within the next 3 seconds.

In some implementations, the measurement setup request frame includes at least a field for whether there are more exchanges, where the field for whether there are more exchanges is used to indicate whether the AP intends to establish more measurement setups and/or intends to terminate one or more existing measurement setups with the STA within the target duration.

In some implementations, the measurement setup request frame includes at least a field for whether there are more exchanges, where the field for whether there are more exchanges includes a first subfield and a second subfield, the first subfield is used to indicate whether the AP intends to establish more measurement setups with the STA within the target duration, and the second subfield is used to indicate whether the AP intends to terminate one or more existing measurement setups with the STA within the target duration.

In some embodiments, in a case where the STA, as a sensing initiating device, actively establishes a measurement setup with the AP, the first indication information is transmitted via a measurement setup response frame.

In some embodiments, in a case where the STA, as the sensing initiating device, actively establishes the measurement setup with the AP, for example, establishes a non-trigger based (non-TB) measurement process, the AP may also inform the STA in advance of future measurement setup and/or measurement setup termination in the measurement setup response frame.

In some implementations, the measurement setup response frame includes at least a field for whether there are more exchanges, where the field for whether there are more exchanges is used to indicate whether the AP intends to establish more measurement setups and/or intends to terminate one or more existing measurement setups with the STA within the target duration.

In some implementations, the measurement setup response frame includes at least a field for whether there are more exchanges, where the field for whether there are more exchanges includes a first subfield and a second subfield, the first subfield is used to indicate whether the AP intends to establish more measurement setups with the STA within the target duration, and the second subfield is used to indicate whether the AP intends to terminate one or more existing measurement setups with the STA within the target duration.

In some embodiments, in a case where the STA, as a sensing by proxy requesting device, transmits a sensing proxy request frame to the AP, the first indication information is transmitted via a sensing proxy response frame.

In some embodiments, in a case where the STA, as a sensing by proxy requesting device (sensing by Proxy requester, SBP requester) (or called a sensing proxy initiating device (SBP requesting STA, SBP Initiator)), actively initiates a sensing proxy process with the AP, that is, transmits a sensing proxy request frame (SBP Request) to the AP, the AP may also inform the STA in advance of future measurement setup and/or measurement setup termination in a sensing proxy response frame (SBP Response).

In some implementations, the sensing proxy response frame includes at least a field for whether there are more exchanges, where the field for whether there are more exchanges is used to indicate whether the AP intends to establish more measurement setups and/or intends to terminate one or more existing measurement setups with the STA within the target duration.

In some implementations, the sensing proxy response frame includes at least a field for whether there are more exchanges, where the field for whether there are more exchanges includes a first subfield and a second subfield, the first subfield is used to indicate whether the AP intends to establish more measurement setups with the STA within the target duration, and the second subfield is used to indicate whether the AP intends to terminate one or more existing measurement setups with the STA within the target duration.

In some embodiments, after the STA, as a sensing by proxy requesting device, actively initiates a sensing proxy process with the AP, when the STA requests a sensing proxy reporting from the AP, the first indication information is transmitted via a sensing proxy reporting frame.

In some embodiments, after the STA, as the sensing by proxy requesting device (sensing by Proxy requester, SBP requester) (or called a sensing proxy initiating device (SBP Initiator)), actively initiates the sensing proxy process with the AP, when the sensing by proxy requesting device requests the sensing proxy reporting from the AP, the AP may also inform the STA in advance of future measurement setup and/or measurement setup termination in the sensing proxy reporting frame (SBP Report).

In some implementations, the sensing proxy reporting frame includes at least a field for whether there are more exchanges, where the field for whether there are more exchanges is used to indicate whether the AP intends to establish more measurement setups and/or intends to terminate one or more existing measurement setups with the STA within the target duration.

In some implementations, the sensing proxy reporting frame includes at least a field for whether there are more exchanges, where the field for whether there are more exchanges includes a first subfield and a second subfield, the first subfield is used to indicate whether the AP intends to establish more measurement setups with the STA within the target duration, and the second subfield is used to indicate whether the AP intends to terminate one or more existing measurement setups with the STA within the target duration.

In some embodiments, after receiving the first indication information, the STA remains available within the target duration to receive measurement setup information and/or measurement setup termination information from the AP.

In some embodiments, after receiving the first indication information, the STA transmits an indication frame to the AP within the target duration, where the indication frame is used to trigger the AP to establish one or more new measurement setups and/or terminate one or more existing measurement setups with the STA.

In some embodiments, the indication frame is allowed not to carry capability information required for establishing a sensing session.

In some embodiments, the indication frame is a sensing session setup request frame or a sensing capability information frame or a response device information frame, or the indication frame is a newly defined action frame.

In some embodiments, after the STA receives the first indication information, optionally, the STA may remain available within a timeout period so as to receive measurement setup and/or a measurement setup termination from the AP. Optionally, the STA may not need to remain available all the time, but instead actively transmits an indication frame to the AP within the timeout period to trigger the measurement setup and/or measurement setup termination of the AP. The indication frame may be the aforementioned sensing session setup request frame (or called a sensing capability information frame, or response device information frame). Optionally, in this case, the indication frame may not carry the capability information required for the sensing session setup. Optionally, in this case, the AP may not respond to the indication frame with a sensing session setup response frame (or called sensing capability information frame). Optionally, the indication frame may also be a newly defined action frame. After receiving the indication frame, the AP will establish one or more new measurement setups and/or terminate one or more existing measurement setups with the STA.

Method embodiments of the present application are described in detail above in combination with FIGS. 3 to 32, and device embodiments of the present application will be described in detail below in combination with FIGS. 33 to 36. It should be understood that the device embodiments correspond to the method embodiments, and their similar descriptions may be referred to the method embodiments.

FIG. 33 is a schematic block diagram of a STA device 400 in accordance with embodiments of the present application. As shown in FIG. 33, the STA device 400 includes:
a communication unit 410 configured to receive the first information; where
the first information is used to indicate whether the access point (AP) is searching for sensing responding devices of first type, and/or, the first information is used to indicate whether the AP supports the STA to participate in sensing functions of first type; and
the sensing responding devices of the first type include the secure sensing responding device and/or the non-secure sensing responding device, and the sensing functions of the first type includes the secure sensing function and/or the non-secure sensing function.

In some embodiments, the communication unit 410 is configured to:
receiving the first information through passive scanning.

In some embodiments, the first information is transmitted via the first frame; and
the first frame is the beacon frame, or the first frame is the directional multi-gigabit (DMG) beacon frame.

In some embodiments, the first frame includes the sensing operation element and/or the robust security network extension element and/or the sensing capability element; where
the sensing operation element includes a first indication field and a second indication field, the first indication field is used to indicate whether the AP is searching for the secure sensing responding device, and the second indication field is used to indicate whether the AP is searching for the non-secure sensing responding device;
the robust security network extension element includes a first indication field, and the first indication field is used to indicate whether the AP is searching for the secure sensing responding device; and
the sensing capability element includes a third indication field and a fourth indication field, the third indication field is used to indicate whether the AP supports the STA to participate in the secure sensing function, and the fourth indication field is used to indicate whether the AP supports the STA to participate in the non-secure sensing function.

In some embodiments, the communication unit 410 is configured to:
receive, via the STA, the first information through active scanning.

In some embodiments, the communication unit 410 is configured to:
in a case where the STA supports the sensing functions of the first type and the STA initiates the sensing measurement, receive the first information through the active scanning; or
in a case where the STA supports the sensing functions of the first type and the STA is searching for the network, receive the first information through the active scanning.

In some embodiments, the first information is transmitted via the probe response frame.

In some embodiments, the probe response frame includes the sensing operation element and/or the robust security network extension element and/or the sensing capability element; where
the sensing operation element includes a first indication field and a second indication field, the first indication field is used to indicate whether the AP is searching for the secure sensing responding device, and
the second indication field is used to indicate whether the AP is searching for the non-secure sensing responding device;
the robust security network extension element includes a first indication field, and the first indication field is used to indicate whether the AP is searching for the secure sensing responding device; and
the sensing capability element includes a third indication field and a fourth indication field, the third indication field is used to indicate whether the AP supports the STA to participate in the secure sensing function, and the fourth indication field is used to indicate whether the AP supports the STA to participate in the non-secure sensing function.

In some embodiments, the sensing capability element further includes a fifth indication field, or the robust security network extension element further includes the fifth indication field; where
the fifth indication field is used to indicate whether the AP supports the secure sensing.

In some embodiments, the first indication field is the field for searching for the secure sensing responding device, and the second indication field is the field for searching for the non-secure sensing responding device.

In some embodiments, the STA is the unassociated STA with the AP, or the STA is the associated STA with the AP.

In some embodiments, if the first information is used to indicate that the AP is searching for the sensing responding devices of the first type, and/or the first information is used to indicate that the AP supports the STA to participate in the sensing functions of the first type, and the STA supports the sensing functions of the first type:
the communication unit 410 is configured to transmit the second information to the AP, where the second information includes the communication capability information of the STA and the sensing capability information of the STA;
the communication unit 410 is further configured to receive the third information transmitted by the AP, where the third information includes the communication capability information of the AP and the sensing capability information of the AP.

In some embodiments, the sensing capability information of the STA includes at least one of: the STA supporting the secure sensing function or the STA supporting the non-secure sensing function.

In some embodiments, the sensing capability information of the AP includes at least one of: the AP supporting the secure sensing function, the AP supporting the non-secure sensing function, the AP supporting the STA to participate in the secure sensing function, or the AP supporting the STA to participate in the non-secure sensing function.

In some embodiments, the second information is transmitted via the second frame, and the third information is transmitted via the third frame;
the second frame is the sensing session setup request frame, and the third frame is the sensing session setup response frame; or the second frame is the sensing probe request frame, and the third frame is the sensing probe response frame; or the second frame is the sensing variant probe request frame, and the third frame is the sensing variant probe response frame.

In some embodiments, the STA is the unassociated STA with the AP, and the third information further includes the unassociation identifier (UID) allocated by the AP to the STA.

In some embodiments, the second frame includes the sensing capability element, and the sensing capability element in the second frame is used to indicate at least one of: whether the STA supports the secure sensing function or whether the STA supports the non-secure sensing function.

In some embodiments, the third frame includes the sensing capability element and the unassociation identifier field; where
the sensing capability element in the third frame is used to indicate at least one of: whether the AP supports the secure sensing function, whether the AP supports the non-secure sensing function, whether the AP supports the STA to participate in the secure sensing function, or whether the AP supports the STA to participate in the non-secure sensing function;
the unassociation identifier field is used to indicate the UID allocated by the AP to the STA.

In some embodiments, the third frame further includes the basic service set (BSS) maximum idle time element, and the BSS maximum idle time element is used to instruct the STA to automatically end the sensing session without interacting with the AP for the first time period.

In some embodiments, the second information is transmitted via the fourth frame, and the third information is transmitted via the fifth frame; where
the fourth frame is the association request frame, and the fifth frame is the association response frame; or the fourth frame is the reassociation request frame, and the fifth frame is the reassociation response frame.

In some embodiments, the STA is the associated STA with the AP, and the third information further includes the association identifier (AID) allocated by the AP to the STA.

In some embodiments, the fourth frame includes the sensing capability element, and the sensing capability element in the fourth frame is used to indicate at least one of: whether the STA supports the secure sensing function or whether the STA supports the non-secure sensing function.

In some embodiments, the fifth frame includes the sensing capability element and the association identifier field; where
the sensing capability element in the fifth frame is used to indicate at least one of: whether the AP supports the secure sensing function, whether the AP supports the non-secure sensing function, whether the AP supports the STA to participate in the secure sensing function, or whether the AP supports the STA to participate in the non-secure sensing function; and
the association identifier field is used to indicate the AID allocated by the AP to the STA.

In some embodiments, the communication unit 410 is further configured to receive fourth information transmitted by the AP; where in a case where the STA is the unassociated STA with the AP, the fourth information is used to indicate the UID allocated by the AP to the STA; or in a case where the STA is the associated STA with the AP, the fourth information is used to indicate the AID allocated by the AP to the STA.

In some embodiments, the fourth information is transmitted via the sixth frame; where
in a case where the AP initiates the sensing measurement setup, the sixth frame is the sensing measurement setup request frame; or
in a case where the STA initiates the sensing measurement setup, the sixth frame is the sensing measurement setup response frame.

In some embodiments, in a case where the STA is the unassociated STA with the AP and the sixth frame is the sensing measurement setup request frame, the action field of the sixth frame includes the response device information field, the response device information field includes the response device identifier field, and the response device identifier field is used to indicate the UID allocated by the AP to the STA; or
in a case where the STA is the associated STA with the AP and the sixth frame is the sensing measurement setup request frame, the action field of the sixth frame includes the response device information field, the response device information field includes the response device identifier field, and the response device identifier field is used to indicate the AID allocated by the AP to the STA.

In some embodiments, in a case where the STA is the unassociated STA with the AP and the sixth frame is the sensing measurement setup response frame, the action field of the sixth frame includes the unassociation identifier field, and the unassociation identifier field is used to indicate the UID allocated by the AP to the STA; or
in a case where the STA is the associated STA with the AP and the sixth frame is the sensing measurement setup response frame, the action field of the sixth frame includes the association identifier field, and the association identifier field is used to indicate the AID allocated by the AP to the STA.

In some embodiments, the STA device 400 further includes a processing unit 420; and
the processing unit 420 is configured to perform the preassociation security negotiation (PASN) before establishing a sensing session; or
the processing unit 420 is configured to perform the preassociation security negotiation (PASN) after establishing the sensing session.

In some embodiments, the communication unit may be a communication interface or a transceiver, or an input/output interface of a communication chip or system on chip. The processor may include one or more processors.

It should be understood that the STA device 400 according to the embodiments of the present application may correspond to the STA in the method embodiments of the present application, and the above-mentioned and other operations and/or functions of various units of the STA device 400 are for implementing the corresponding processes of the STA in the method 200 as shown in FIGS. 3 to 26, which will not be repeated here for brevity.

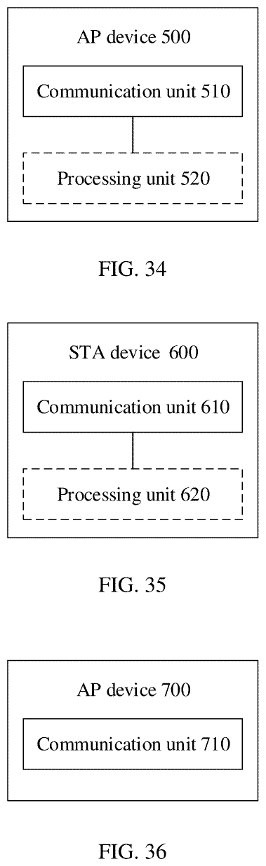

FIG. 34 is a schematic block diagram of an AP device 500 in accordance with embodiments of the present application. As shown in FIG. 34, the AP device 500 includes:
a communication unit 510 configured to transmit first information; where
the first information is used to indicate whether the AP is searching for the sensing responding devices of the first type, and/or the first information is used to indicate whether the AP supports the station (STA) to participate in the sensing functions of the first type; and
the sensing responding devices of the first type include the secure sensing responding device and/or the non-secure sensing responding device, and the sensing functions of the first type include the secure sensing function and/or the non-secure sensing function.

In some embodiments, the first information is received by the STA through passive scanning.

In some embodiments, the first information is transmitted via the first frame; and
the first frame is the beacon frame, or the first frame is the directional multi-gigabit (DMG) beacon frame.

In some embodiments, the first frame includes the sensing operation element and/or the robust security network extension element and/or the sensing capability element;
the sensing operation element includes the first indication field and the second indication field, the first indication field is used to indicate whether the AP is searching for the secure sensing responding device, and the second indication field is used to indicate whether the AP is searching for the non-secure sensing responding device;
the robust security network extension element includes the first indication field, and the first indication field is used to indicate whether the AP is searching for the secure sensing responding device; and
the sensing capability element includes the third indication field and the fourth indication field, the third indication field is used to indicate whether the AP supports the STA to participate in the secure sensing function, and the fourth indication field is used to indicate whether the AP supports the STA to participate in the non-secure sensing function.

In some embodiments, the first information is received by the STA through the active scanning.

In some embodiments, in a case where the STA supports the sensing functions of the first type and the STA initiates the sensing measurement, the first information is received by the STA through the active scanning; or
in a case where the STA supports the sensing functions of the first type and the STA is searching for the network, the first information is received by the STA through the active scanning.

In some embodiments, the first information is transmitted via the probe response frame.

In some embodiments, the probe response frame includes the sensing operation element and/or the robust security network extension element and/or the sensing capability element; where
the sensing operation element includes the first indication field and the second indication field, the first indication field is used to indicate whether the AP is searching for the secure sensing responding device, and the second indication field is used to indicate whether the AP is searching for the non-secure sensing responding device;
the robust security network extension element includes the first indication field, and the first indication field is used to indicate whether the AP is searching for the secure sensing responding device; and
the sensing capability element includes the third indication field and the fourth indication field, the third indication field is used to indicate whether the AP supports the STA to participate in the secure sensing function, and the fourth indication field is used to indicate whether the AP supports the STA to participate in the non-secure sensing function.

In some embodiments, the sensing capability element further includes the fifth indication field, or the robust security network extension element further includes the fifth indication field; and
the fifth indication field is used to indicate whether the AP supports the secure sensing.

In some embodiments, the first indication field is the field for searching for the secure sensing responding device, and the second indication field is the field for searching for the non-secure sensing responding device.

In some embodiments, the STA is the unassociated STA with the AP, or the STA is the associated STA with the AP.

In some embodiments, if the first information is used to indicate that the AP is searching for the sensing responding devices of the first type, and/or the first information is used to indicate that the AP supports the STA to participate in the sensing functions of the first type, and the STA supports the sensing functions of the first type;
the communication unit 510 is further configured to receive the second information transmitted by the STA, where the second information includes the communication capability information of the STA and the sensing capability information of the STA;
the communication unit 510 is further configured to transmit the third information to the STA, where the third information includes the communication capability information of the AP and the sensing capability information of the AP.

In some embodiments, the sensing capability information of the STA includes at least one of: the STA supporting the secure sensing function or the STA supporting the non-secure sensing function.

In some embodiments, the sensing capability information of the AP includes at least one of: the AP supporting the secure sensing function, the AP supporting the non-secure sensing function, the AP supporting the STA to participate in the secure sensing function, or the AP supporting the STA to participate in the non-secure sensing function.

In some embodiments, the second information is transmitted via the second frame, and the third information is transmitted via the third frame; where
the second frame is the sensing session setup request frame, and the third frame is the sensing session setup response frame; or the second frame is the sensing probe request frame, and the third frame is the sensing probe response frame; or the second frame is the sensing variant probe request frame, and the third frame is the sensing variant probe response frame.

In some embodiments, the STA is the unassociated STA with the AP, and the third information further includes the unassociation identifier (UID) allocated by the AP to the STA.

In some embodiments, the second frame includes the sensing capability element, where the sensing capability element in the second frame is used to indicate at least one of: whether the STA supports the secure sensing function or whether the STA supports the non-secure sensing function.

In some embodiments, the third frame includes the sensing capability element and the unassociation identifier field; where
the sensing capability element in the third frame is used to indicate at least one of: whether the AP supports the secure sensing function, whether the AP supports the non-secure sensing function, whether the AP supports the STA to participate in the secure sensing function, or whether the AP supports the STA to participate in the non-secure sensing function; and
the unassociation identifier field is used to indicate the UID allocated by the AP to the STA.

In some embodiments, the third frame further includes the basic service set (BSS) maximum idle time element, where the BSS maximum idle time element is used to instruct the STA to automatically end the sensing session without interacting with the AP for the first time period.

In some embodiments, the second information is transmitted via the fourth frame, and the third information is transmitted via the fifth frame; where
the fourth frame is the association request frame, and the fifth frame is the association response frame; or the fourth frame is the reassociation request frame, and the fifth frame is the reassociation response frame.

In some embodiments, the STA is the associated STA with the AP, and the third information further includes the association identifier (AID) allocated by the AP to the STA.

In some embodiments, the fourth frame includes the sensing capability element, and the sensing capability element in the fourth frame is used to indicate at least one of: whether the STA supports the secure sensing function or whether the STA supports the non-secure sensing function.

In some embodiments, the fifth frame includes the sensing capability element and the association identifier field; where
the sensing capability element in the fifth frame is used to indicate at least one of: whether the AP supports the secure sensing function, whether the AP supports the non-secure sensing function, whether the AP supports the STA to participate in the secure sensing function, or whether the AP supports the STA to participate in the non-secure sensing function; and
the association identifier field is used to indicate the AID allocated by the AP to the STA.

In some embodiments, the communication unit 510 is further configured to transmit fourth information to the STA; where
in a case where the STA is the unassociated STA with the AP, the fourth information is used to indicate the UID allocated by the AP to the STA; or in a case where the STA is the associated STA with the AP, the fourth information is used to indicate the AID allocated by the AP to the STA.

In some embodiments, the fourth information is transmitted via the sixth frame; where
in a case where the AP initiates the sensing measurement setup, the sixth frame is the sensing measurement setup request frame; or
in a case where the STA initiates the sensing measurement setup, the sixth frame is the sensing measurement setup response frame.

In some embodiments, in a case where the STA is the unassociated STA with the AP and the sixth frame is the sense measurement setup request frame, the action field of the sixth frame includes the response device information field, the response device information field includes the response device identifier field, and the response device identifier field is used to indicate the UID allocated by the AP to the STA; or
in a case where the STA is the associated STA with the AP and the sixth frame is the sensing measurement setup request frame, the action field of the sixth frame includes the response device information field, and the response device information field includes the response device identifier field, and the response device identifier field is used to indicate the AID allocated by the AP to the STA.

In some embodiments, in a case where the STA is the unassociated STA with the AP and the sixth frame is the sensing measurement setup response frame, the action field of the sixth frame includes the unassociation identifier field, and the unassociation identifier field is used to indicate the UID allocated by the AP to the STA; or
in a case where the STA is the associated STA with the AP and the sixth frame is the sensing measurement setup response frame, the action field of the sixth frame includes the association identifier field, and the association identifier field is used to indicate the AID allocated by the AP to the STA.

In some embodiments, the AP device 500 further includes a processing unit 520; where
the processing unit 520 is configured to perform the preassociation security negotiation (PASN) before establishing the sensing session; or
the processing unit 520 is configured to perform the preassociation security negotiation (PASN) after establishing the sensing session.

In some embodiments, the communication unit may be a communication interface or a transceiver, or an input/output interface of a communication chip or system on chip. The processor may include one or more processors.

It should be understood that the AP device 500 according to the embodiments of the present application may correspond to the AP in the method embodiments of the present application, and the above-mentioned and other operations and/or functions of various units of the AP device 500 are for implementing the corresponding processes of the AP in the method 200 as shown in FIGS. 3 to 26, which will not be repeated here for brevity.

FIG. 35 is a schematic block diagram of a STA device 600 in accordance with embodiments of the present application. As shown in FIG. 35, the STA device 600 includes:
a communication unit 610 configured to receive the first indication information transmitted by the access point (AP);
where the first indication information is used to indicate the new measurement setup and/or measurement setup termination with the STA within the target duration.

In some embodiments, the STA is the associated STA with the AP, or the STA is the unassociated STA with the AP.

In some embodiments, the first indication information is transmitted by the AP in the polling phase.

In some embodiments, the AP indicates that the STA will be polled in the polling phase when performing the measurement setup with the STA; or
the AP defaults to polling the STA in the polling phase when performing the measurement setup with the STA.

In some embodiments, the STA is an unassociated STA with the AP.

In some embodiments, the first indication information is transmitted via the polling trigger frame.

In some embodiments, the first indication information is transmitted by the AP in one of following phases:
the polling phase, the uplink sounding phase, the downlink sounding phase.

In some embodiments, if the polling phase exists, the first indication information is transmitted via the polling trigger frame; and/or
if the polling phase does not exist, the uplink sounding phase exists and the STA participates in the uplink sounding, the first indication information is transmitted via the sounding trigger frame; and/or
if the polling phase does not exist, the downlink sounding phase exists and the STA participates in the downlink sounding, the first indication information is transmitted via the sounding announcement frame.

In some embodiments, in a case where the AP indicates that the STA performs the threshold based reporting, the first indication information is transmitted via the threshold check polling frame.

In some embodiments, the polling trigger frame includes the field for whether there are more exchanges, where the field for whether there are more exchanges is used to indicate whether the AP intends to establish more measurement setups and/or intends to terminate one or more existing measurement setups with the STA within the target duration.

In some embodiments, the polling trigger frame includes the field for whether there are more exchanges;
where the field for whether there are more exchanges includes the first subfield and the second subfield, the first subfield is used to indicate whether the AP intends to establish more measurement setups with the STA within the target duration, and the second subfield is used to indicate whether the AP intends to terminate one or more existing measurement setups with the STA within the target duration.

In some embodiments, the polling trigger frame includes the field for whether there are more measurement setups and the field for whether to terminate the measurement setup;
where the field for whether there are more measurement setups is used to indicate whether the AP intends to establish more measurement setups with the STA within the target duration, and the field for whether to terminate the measurement setup is used to indicate whether the AP intends to terminate the measurement setup corresponding to the measurement setup identifier in the common information with the STA within the target duration.

In some embodiments, the sounding trigger frame includes the field for whether there are more measurement setups, where the field for whether there are more measurement setups is used to indicate whether the AP intends to establish more measurement setups with the STA within the target duration; or
the sounding trigger frame includes the field for whether there are more exchanges, where the field for whether there are more exchanges includes the first subfield and the second subfield, the first subfield is used to indicate whether the AP intends to establish more measurement setups with the STA within the target duration, and the second subfield is used to indicate whether the AP intends to terminate one or more existing measurement setups with the STA within the target duration.

In some embodiments, the sounding announcement frame includes the field for whether it is used for sensing and the field for whether there are more measurement setups;
where the field for whether it is used for sensing is used to indicate whether the sounding announcement frame is the sounding announcement frame for sensing, and the field for whether there are more measurement setups is used to indicate whether the AP intends to establish more measurement setups with the STA within the target duration.

In some embodiments, the sounding announcement frame includes the field for whether it is used for sensing and the field for whether there are more exchanges;
where the field for whether it is used for sensing is used to indicate whether the sounding announcement frame is the sounding announcement frame for sensing, and the field for whether there are more exchanges includes the first subfield and the second subfield. The first subfield is used to indicate whether the AP intends to establish more measurement setups with the STA within the target duration, and the second subfield is used to indicate whether the AP intends to terminate one or more existing measurement setups with the STA within the target duration.

In some embodiments, in the trigger based measurement instance and/or in the non-trigger based measurement instance, the first indication information is transmitted via the sensing reporting trigger frame, and/or, the first indication information is transmitted via the sensing reporting frame.

In some embodiments, in a case where the AP needs to request the STA to transmit the sensing reporting, the first indication information is transmitted via the sensing reporting trigger frame; and/or
in a case where the AP transmits the sensing reporting to the STA, the first indication information is transmitted via the sensing reporting frame.

In some embodiments, the first indication information is transmitted via the measurement setup request frame transmitted by the AP to establish the target measurement setup with the STA.

In some embodiments, in a case where the STA, as the sensing initiating device, actively establishes the measurement setup with the AP, the first indication information is transmitted via the measurement setup response frame.

In some embodiments, in a case where the STA, as the sensing by proxy requesting device, transmits the sensing proxy request frame to the AP, the first indication information is transmitted via the sensing proxy response frame; and/or
after the STA, as the sensing by proxy requesting device, actively initiates the sensing proxy process with the AP, when the STA requests the sensing proxy reporting from the AP, the first indication information is transmitted via the sensing proxy reporting frame.

In some embodiments, the frame carrying the first indication information includes at least the field for whether there are more exchanges;
where the field for whether there are more exchanges is used to indicate whether the AP establishes more measurement setups and/or terminates one or more existing measurement setups with the STA within the target duration.

In some embodiments, the frame carrying the first indication information includes at least the field for whether there are more exchanges;
where the field for whether there are more exchanges includes the first subfield and the second subfield, the first subfield is used to indicate whether the AP intends to establish more measurement setups with the STA within the target duration, and the second subfield is used to indicate whether the AP intends to terminate one or more existing measurement setups with the STA within the target duration.

In some embodiments, the STA device 600 further includes a processing unit 620;
after receiving the first indication information, the processing unit 620 is configured to remain available within the target duration to receive measurement setup information and/or measurement setup termination information from the AP.

In some embodiments, after receiving the first indication information, the communication unit 610 is further configured to transmit the indication frame to the AP within the target duration;
where the indication frame is used to trigger the AP to establish one or more new measurement setups and/or terminate one or more existing measurement setups with the STA.

In some embodiments, the indication frame is allowed to not carry capability information required for the sensing session setup.

In some embodiments, the indication frame is the sensing session setup request frame or the sensing capability information frame or the response device information frame, or the indication frame is the newly defined action frame.

In some embodiments, the communication unit 610 is further configured to transmit the first capability information to the AP, where the first capability information is used to indicate whether the STA supports measurement that does not need polling.

In some embodiments, the communication unit 610 is further configured to receive the second indication information transmitted by the AP, where the second indication information is used to indicate whether the AP polls the STA in the polling phase.

In some embodiments, in a case where the STA does not support measurement that does not need polling, the AP does not establish the measurement setup with the STA, or the AP polls the STA in the polling phase in the process of establishing a measurement setup with the STA; or
in a case where the STA supports measurement that does not need polling, the AP indicates to poll the STA in the polling phase in the process of establishing the measurement setup with the STA, or the AP indicates not to poll the STA in the polling phase in the process of establishing the measurement setup with the STA.

In some embodiments, the second indication information is transmitted via the measurement setup request frame;
where the measurement setup request frame includes the field for whether to be polled, and the field for whether to be polled is used to indicate whether the STA will be polled in the polling phase of the trigger based measurement instance.

In some embodiments, the measurement setup request frame further includes the field for whether there are more exchanges;
where the field for whether there are more exchanges is used to indicate whether the AP intends to establish more measurement setups and/or intends to terminate one or more existing measurement setups with the STA within the target duration; or, the field for whether there are more exchanges includes the first subfield and the second subfield, the first subfield is used to indicate whether the AP intends to establish more measurement setups with the STA within the target duration, and the second subfield is used to indicate whether the AP intends to terminate one or more existing measurement setups with the STA within the target duration.

In some embodiments, the target duration is the predefined timeout period, or the target duration is the timeout period indicated by the AP.

In some embodiments, the communication unit may be a communication interface or a transceiver, or an input/output interface of a communication chip or system on chip. The processing unit may include one or more processors.

It should be understood that the STA device 600 according to the embodiments of the present application may correspond to the STA in the method embodiments of the present application, and the above-mentioned and other operations and/or functions of various units of the STA device 600 are for implementing the corresponding processes of the STA in the method 300 as shown in FIGS. 27 to 32, which will not be repeated here for brevity.

FIG. 36 illustrates a schematic block diagram of an AP device 700 in accordance with embodiments of the present application. As shown in FIG. 36, the AP device 700 includes:
a communication unit 710 configured to transmit first indication information to the station (STA);
where the first indication information is used to indicate the new measurement setup and/or measurement setup termination with the STA within the target duration.

In some embodiments, the STA is the associated STA with the AP, or the STA is the unassociated STA with the AP.

In some embodiments, the first indication information is transmitted by the AP in the polling phase.

In some embodiments, the AP indicates that the STA will be polled in the polling phase when performing the measurement setup with the STA; or
the AP defaults to polling the STA in the polling phase when performing the measurement setup with the STA.

In some embodiments, the STA is the unassociated STA with the AP.

In some embodiments, the first indication information is transmitted via the polling trigger frame.

In some embodiments, the first indication information is transmitted by the AP in one of following phases:
the polling phase, the uplink sounding phase, the downlink sounding phase.

In some embodiments, if the polling phase exists, the first indication information is transmitted via a polling trigger frame; and/or
if the polling phase does not exist, the uplink sounding phase exists and the STA participates in the uplink sounding, the first indication information is transmitted via the sounding trigger frame; and/or
if the polling phase does not exist, the downlink sounding phase exists and the STA participates in the downlink sounding, the first indication information is transmitted via the sounding announcement frame.

In some embodiments, in a case where the AP indicates that the STA performs the threshold based reporting, the first indication information is transmitted via the threshold check polling frame.

In some embodiments, the polling trigger frame includes the field for whether there are more exchanges; where the field for whether there are more exchanges is used to indicate whether the AP intends to establish more measurement setups and/or intends to terminate one or more existing measurement setups with the STA within the target duration.

In some embodiments, the polling trigger frame includes the field for whether there are more exchanges;
where the field for whether there are more exchanges includes the first subfield and the second subfield, the first subfield is used to indicate whether the AP intends to establish more measurement setups with the STA within the target duration, and the second subfield is used to indicate whether the AP intends to terminate one or more existing measurement setups with the STA within the target duration.

In some embodiments, the polling trigger frame includes the field for whether there are more measurement setups and the field for whether to terminate the measurement setup;
where the field for whether there are more measurement setups is used to indicate whether the AP intends to establish more measurement setups with the STA within the target duration, and the field for whether to terminate the measurement setup is used to indicate whether the AP intends to terminate the measurement setup corresponding to the measurement setup identifier in the common information with the STA within the target duration.

In some embodiments, the sounding trigger frame includes the field for whether there are more measurement setups, where the field for whether there are more measurement setups is used to indicate whether the AP intends to establish more measurement setups with the STA within the target duration; or
the sounding trigger frame includes a field for whether there are more exchanges, where the field for whether there are more exchanges includes the first subfield and the second subfield, the first subfield is used to indicate whether the AP intends to establish more measurement setups with the STA within the target duration, and the second subfield is used to indicate whether the AP intends to terminate one or more existing measurement setups with the STA within the target duration.

In some embodiments, the sounding announcement frame includes the field for whether it is used for sensing and the field for whether there are more measurement setups;
where the field for whether it is used for sensing is used to indicate whether the sounding announcement frame is the sounding announcement frame for sensing, and the field for whether there are more measurement setups is used to indicate whether the AP intends to establish more measurement setups with the STA within the target duration.

In some embodiments, the sounding announcement frame includes the field for whether it is used for sensing and the field for whether there are more exchanges;
where the field for whether it is used for sensing is used to indicate whether the sounding announcement frame is the sounding announcement frame for sensing, and the field for whether there are more exchanges includes the first subfield and the second subfield. The first subfield is used to indicate whether the AP intends to establish more measurement setups with the STA within the target duration, and the second subfield is used to indicate whether the AP intends to terminate one or more existing measurement setups with the STA within the target duration.

In some embodiments, in the trigger based measurement instance and/or in the non-trigger based measurement instance, the first indication information is transmitted via the sensing reporting trigger frame, and/or, the first indication information is transmitted via the sensing reporting frame.

In some embodiments, in a case where the AP needs to request the STA to transmit the sensing reporting, the first indication information is transmitted via the sensing reporting trigger frame; and/or
in a case where the AP transmits the sensing reporting to the STA, the first indication information is transmitted via the sensing reporting frame.

In some embodiments, the first indication information is transmitted via the measurement setup request frame transmitted by the AP to establish the target measurement setup with the STA.

In some embodiments, in a case where the STA, as the sensing initiating device, actively establishes the measurement setup with the AP, the first indication information is transmitted via the measurement setup response frame.

In some embodiments, in a case where the STA, as the sensing by proxy requesting device, transmits the sensing proxy request frame to the AP, the first indication information is transmitted via the sensing proxy response frame; and/or
after the STA, as the sensing by proxy requesting device, actively initiates the sensing proxy process with the AP, when the STA requests the sensing proxy reporting from the AP, the first indication information is transmitted via the sensing proxy reporting frame.

In some embodiments, the frame carrying the first indication information includes at least the field for whether there are more exchanges;
where the field for whether there are more exchanges is used to indicate whether the AP intends to establish more measurement setups and/or intends to terminate one or more existing measurement setups with the STA within the target duration.

In some embodiments, the frame carrying the first indication information includes at least the field for whether there are more exchanges;
where the field for whether there are more exchanges includes the first subfield and the second subfield, the first subfield is used to indicate whether the AP intends to establish more measurement setups with the STA within the target duration, and the second subfield is used to indicate whether the AP intends to terminate one or more existing measurement setups with the STA within the target duration.

In some embodiments, the communication unit 710 is further configured to transmit the measurement setup information and/or the measurement setup termination information to the STA within the target duration;
where the STA remains available within the target duration.

In some embodiments, the communication unit 710 is further configured to receive the indication frame transmitted by the STA within the target duration;
where the indication frame is used to trigger the AP to establish one or more new measurement setups and/or terminate one or more existing measurement setups with the STA.

In some embodiments, the indication frame is allowed to not carry the capability information required for the sensing session setup.

In some embodiments, the indication frame is the sensing session setup request frame or the sensing capability information frame or the response device information frame, or the indication frame is the newly defined action frame.

In some embodiments, the communication unit 710 is further configured to receive the first capability information transmitted by the STA, where the first capability information is used to indicate whether the STA supports measurement that does not need polling.

In some embodiments, the communication unit 710 is further configured to transmit the second indication information to the STA, where the second indication information is used to indicate whether the AP polls the STA in the polling phase.

In some embodiments, in a case where the STA does not support measurement that does not need polling, the AP does not establish a measurement setup with the STA, or the AP indicates to poll the STA in the polling phase in a process of establishing a measurement setup with the STA; or
in a case where the STA supports measurement that does not need polling, the AP indicates to poll the STA in the polling phase in the process of establishing the measurement setup with the STA, or the AP indicates not to poll the STA in the polling phase in the process of establishing the measurement setup with the STA.

In some embodiments, the second indication information is transmitted via the measurement setup request frame;
where the measurement setup request frame includes the field for whether to be polled, and the field for whether to be polled is used to indicate whether the STA will be polled in the polling phase of the trigger based measurement instance.

In some embodiments, the measurement setup request frame further includes the field for whether there are more exchanges;
where the field for whether there are more exchanges is used to indicate whether the AP intends to establish more measurement setups and/or intends to terminate one or more existing measurement setups with the STA within the target duration; or, the field for whether there are more exchanges includes the first subfield and the second subfield, the first subfield is used to indicate whether the AP intends to establish more measurement setups with the STA within the target duration, and the second subfield is used to indicate whether the AP intends to terminate one or more existing measurement setups with the STA within the target duration.

In some embodiments, the target duration is the predefined timeout period, or the target duration is the timeout period indicated by the AP.

In some embodiments, the communication unit may be a communication interface or a transceiver, or an input/output interface of a communication chip or system on chip. The processing unit may include one or more processors.

It should be understood that the AP device 700 according to the embodiments of the present application may correspond to the AP in the method embodiments of the present application, and the above-mentioned and other operations and/or functions of various units of the AP device 700 are for implementing the corresponding processes of the AP in the method 300 as shown in FIGS. 27 to 32, which will not be repeated here for brevity.

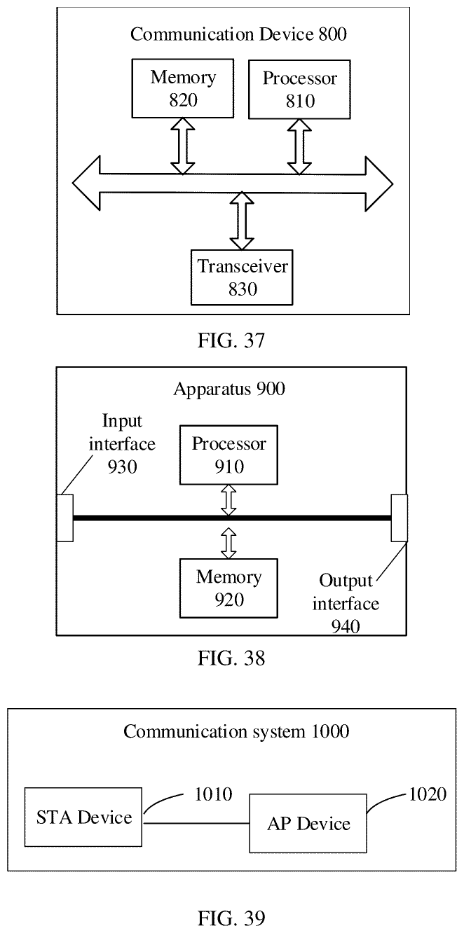

FIG. 37 is a schematic diagram showing a communication device 800 in accordance with embodiments of the present application. The communication device 800 shown in FIG. 37 includes a processor 810, which may invoke and execute a computer program from a memory to implement the methods in the embodiments of the present application.

In some embodiments, as shown in FIG. 37, the communication device 800 further includes a memory 820. The processor 810 may invoke and execute the computer program from the memory 820 to implement the methods in the embodiments of the present application.

The memory 820 may be a separate device independent of the processor 810, or may be integrated into the processor 810.

In some embodiments, as shown in FIG. 37, the communication device 800 may further include a transceiver 830, and the processor 810 may control the transceiver 830 to communicate with other devices. In some embodiments, the transceiver 830 may transmit information or data to other devices, or receive information or data transmitted by other devices.

The transceiver 830 may include a transmitter and a receiver. The transceiver 830 may further include antennas, the number of which may be one or more.

In some embodiments, the communication device 800 may be the AP device of the embodiments of the present application, and the communication device 800 may implement the corresponding processes implemented by the AP in each method of the embodiments of the present application, which will not be repeated here for brevity.

In some embodiments, the communication device 800 may be the STA device of the embodiments of the present application, and the communication device 800 may implement the corresponding processes implemented by the STA in each method of the embodiments of the present application, which will not be repeated here for brevity.

FIG. 38 is a schematic block diagram of an apparatus of the embodiments of the present application. The apparatus 900 shown in FIG. 38 includes a processor 910, which may invoke and execute a computer program from a memory to implement the methods in the embodiments of the present application.

In some embodiments, as shown in FIG. 38, the apparatus 900 may further include a memory 920. The processor 910 may invoke and execute a computer program from the memory 920 to implement the methods of the embodiments of the present application.

The memory 920 may be a separate device independent of the processor 910, or may be integrated into the processor 910.

In some embodiments, the apparatus 900 further includes an input interface 930. The processor 910 may control the input interface 930 to communicate with other devices or chips. In some embodiments, the input interface 930 may obtain information or data transmitted by other devices or chips.

In some embodiments, the apparatus 900 further includes an output interface 940. The processor 910 may control the output interface 940 to communicate with other devices or chips. In some embodiments, the output interface 940 may output information or data to other devices or chips.

In some embodiments, the apparatus may be applied to the AP device in the embodiments of the present application, and the apparatus may implement the corresponding processes implemented by the AP in various methods in the embodiments of the present application, which will not be repeated here for brevity.

In some embodiments, the apparatus may be applied to the STA device in the embodiments of the present application, and the apparatus may implement the corresponding processes implemented by the STA in various methods in the embodiments of the present application, which will not be repeated here for brevity.

In some embodiments, the apparatus mentioned in the embodiments of the present application may be a chip. For example, it may be a system-level chip, a system chip, a chip system, a system-on-chip, or the like.

FIG. 39 is a schematic block diagram of a communication system 1000 provided by the embodiments of the present application. As shown in FIG. 39, the communication system 1000 includes a STA device 1010 and an AP device 1020.

Here, the STA device 1010 may be used to implement corresponding functions implemented by the STA in the above methods, and the AP device 1020 may be used to implement corresponding functions implemented by the AP in the above method, which will not be repeated here for brevity.

It should be understood that the processor of the embodiments of the present application may be an integrated circuit chip with signal processing capabilities. In an implementation process, various steps of the embodiments of the methods may be implemented by an integrated logic circuit of hardware in a processor or instructions in a software form. The processor may be a general-purpose processor, a digital signal processor (DSP), an application specific integrated circuit (ASIC), a field programmable gate array (FPGA) or other programmable logic devices, a discrete gate, a transistor logic device, a discrete hardware component, which may execute the various methods, steps and logic diagrams disclosed in the embodiments of the present application. The general-purpose processor may be a microprocessor or any conventional processor. Steps of the methods disclosed in the embodiments of the present application may be directly embodied as being performed by a hardware decoding processor, or may be implemented by a combination of a hardware in the decoding processor and a software module. The software module may be located in a random access memory, a flash memory, a read-only memory, a programmable read-only memory, or an electrically erasable programmable memory, a register, or other mature storage medium in the art. The storage medium is located in the memory, and the processor reads information in the memory and implements the steps of the above method in combination with its hardware.

It can be understood that the memory in the embodiments of the present application may be a volatile or non-volatile memory, or may include both volatile and non-volatile memories. Herein, the non-volatile memory may be a read-only memory (ROM), a programmable ROM (PROM), an erasable programmable read-only memory (Erasable PROM, EPROM), an electrically erasable programmable read-only memory (Electrically EPROM, EEPROM) or a flash memory. The volatile memory may be a random access memory (RAM), which acts as external cache memory. By way of example and not limitation, many forms of RAM are available, such as a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synchlink DRAM, SLDRAM) and a direct rambus random access memory (Direct Rambus RAM, DR RAM). It should be noted that the memory of the systems and methods described herein is intended to include, but is not limited to, these and any other suitable types of memory.

It should be understood that the above-mentioned memory is exemplary but not limitation. For example, the memory in the embodiments of the present application may also be a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), enhanced synchronous dynamic random access memory (enhanced SDRAM, ESDRAM), synchronous link dynamic random access memory (synch link DRAM, SLDRAM), direct memory bus random access memory (Direct Rambus RAM, DR RAM), or the like. That is, the memory in the embodiments of the present application is intended to include, but is not limited to, these and any other suitable types of memory.

Embodiments of the present application further provide a non-transitory computer readable storage medium for storing a computer program.

In some embodiments, the non-transitory computer readable storage medium may be applied to the AP device in the embodiments of the present application, and the computer program enables the computer to execute corresponding processes implemented by the AP in the various methods of the embodiments of the present application, which will not be repeated here for brevity.

In some embodiments, the non-transitory computer readable storage medium may be applied to the STA device in the embodiments of the present application, and the computer program enables the computer to execute corresponding processes implemented by the STA device in the various methods of the embodiments of the present application, which will not be repeated here for brevity.

Embodiments of the present application further provide a computer program product including computer program instructions.

In some embodiments, the computer program product may be applied to the AP device in the embodiments of the present application, and the computer program instructions enable the computer to execute corresponding processes implemented by the AP in the various methods of the embodiments of the present application, which will not be repeated here for brevity.

In some embodiments, the computer program product may be applied to the STA device in the embodiments of the present application, and the computer program instructions enable the computer to execute corresponding processes implemented by the STA in the various methods of the embodiments of the present application, which will not be repeated here for brevity.

Embodiments of the present application further provide a computer program.

In some embodiments, the computer program may be applied to the AP device in the embodiments of the present application. When the computer program runs on a computer, the computer executes corresponding processes implemented by the AP in the various methods of the embodiments of the present application, which will not be repeated here for brevity.

In some embodiments, the computer program may be applied to the STA device in the embodiments of the present application. When the computer program runs on a computer, the computer executes corresponding processes implemented by the STA in the various methods of the embodiments of the present application, which will not be repeated here for brevity.

Those skilled in the art may realize that the present application may be implemented in an electronic hardware or in a combination of the electronic hardware and a computer software with reference to units and algorithm steps of each example described in the embodiments disclosed herein. Whether these functions are performed by hardware or software depends on specific application and design constraints of the technical solutions. A skilled person can use different methods for each specific application to implement the described functions, but such implementation should not be considered beyond the scope of the present application.

Those skilled in the art may clearly understand that for the convenience and brevity of description, working processes of the systems, devices and units described above may refer to the corresponding processes in the above embodiments of the methods, and details will not be repeated here.

In the embodiments provided by the present application, it should be understood that the systems, devices and methods may be implemented in other ways. For example, the embodiments of the apparatus described above are merely exemplary. For example, a division of the units is only a logical functional division. In the actual implementation, there are other division manners. For example, multiple units or components may be combined or integrated into another system, or some features may be ignored or not executed. On the other hand, the mutual coupling or direct coupling or communication connection shown or discussed may be an indirect coupling or communication connection through some interfaces, devices or units, and may be in electrical, mechanical or other forms.

The units described as separate components may or may not be physically separated, and the components shown as units may or may not be physical units that is, they may be located in one place, or may be distributed to multiple network units. Part or all of the units may be selected according to actual needs to achieve the purpose of the solutions of the embodiments.

In addition, functional units in the embodiments of the present application may be integrated into a single processing unit or may be separate physical units, or two or more units may be integrated into a single unit.

The functions, if implemented in the form of a software functional unit and sold or used as an independent product, may be stored in a non-transitory computer readable storage medium. Based on this understanding, the technical solutions of the present application in essential or a part of the technical solutions contributes to the related technology, or a part of the technical solutions may be embodied in a form of a software product. The computer software product may be stored in a non-transitory computer readable storage medium, and include a plurality of instructions for enabling a computer device (which may be a personal computer, a server, a network device, etc.) to perform all or part of the methods as described in the embodiments of the present application. The aforementioned storage medium: includes various types of medium capable of storing program codes, such as a USB flash drive, a mobile disk, a read-only memory (ROM), a random access memory (RAM), a magnetic disk, or an optical disk, or the like.

The foregoing descriptions are merely some implementations of the present application, but the protection scope of the present application is not limited thereto. Any skilled person in the art could readily conceive of changes or replacements within the technical scope of the present application, which shall all be included in the protection scope of the present application. Therefore, the protection scope of the present application shall be subject to the protection scope of the claims.

What is claimed is:

1. A method for wireless communication, comprising:
receiving, by a station (STA), first indication information transmitted by an access point (AP);
wherein the first indication information is used to indicate new measurement setup and/or measurement setup termination with the STA within a target duration.

2. A STA device, comprising a processor and a memory, wherein the memory is configured to store a computer program, and the processor is configured to invoke and execute the computer program stored in the memory, causing the STA device to perform:
receiving first indication information transmitted by an access point (AP);
wherein the first indication information is used to indicate new measurement setup and/or measurement setup termination with the STA within a target duration;
wherein the STA is an associated STA with the AP, or the STA is an unassociated STA with the AP.

3. The STA device of claim 2, wherein
the first indication information is transmitted by the AP in a polling phase;
wherein the first indication information is transmitted via a polling trigger frame.

4. The STA device of claim 3, wherein
the AP indicates that the STA will be polled in the polling phase when performing measurement setup with the STA; or
the AP defaults to polling the STA in the polling phase when performing measurement setup with the STA;
wherein the STA is an unassociated STA with the AP.

5. The STA device of claim 2, wherein
the first indication information is transmitted by the AP in one of following phases:
a polling phase, an uplink sounding phase, a downlink sounding phase.

6. The STA device of claim 5, wherein
if the polling phase exists, the first indication information is transmitted via a polling trigger frame; and/or
if the polling phase does not exist, the uplink sounding phase exists and the STA participates in uplink sounding, the first indication information is transmitted via a sounding trigger frame; and/or
if the polling phase does not exist, the downlink sounding phase exists and the STA participates in downlink sounding, the first indication information is transmitted via a sounding announcement frame.

7. The STA device of claim 6, wherein
the sounding announcement frame comprises a field for whether it is used for sensing and a field for whether there are more exchanges;
wherein the field for whether it is used for sensing is used to indicate whether the sounding announcement frame is a sounding announcement frame for sensing, and the field for whether there are more exchanges comprises a first subfield and a second subfield, wherein the first subfield is used to indicate whether the AP intends to establish new measurement setups with the STA within the target duration, and the second subfield is used to indicate whether the AP intends to terminate one or more existing measurement setups with the STA within the target duration.

8. The STA device of claim 2, wherein the first indication information is transmitted via a measurement setup request frame transmitted by the AP to establish a target measurement setup with the STA.

9. The STA device of claim 2, after receiving the first indication information, the STA device further performing:
transmitting an indication frame to the AP within the target duration;
wherein the indication frame is used to trigger the AP to establish one or more new measurement setups and/or terminate one or more existing measurement setups with the STA.

10. The STA device of claim 9, wherein
the indication frame is a sensing session setup request frame or a sensing capability information frame or a response device information frame, or the indication frame is a newly defined action frame.

11. The STA device of claim 2, the STA device further performing:
transmitting first capability information to the AP, wherein the first capability information is used to indicate whether the STA supports measurement that does not need polling.

12. The STA device of claim 11, the STA device further performing:
receiving second indication information transmitted by the AP, wherein the second indication information is used to indicate whether the AP polls the STA in a polling phase.

13. The STA device of claim 12, wherein
the second indication information is transmitted via a measurement setup request frame;
wherein the measurement setup request frame comprises a field for whether to be polled, and the field for whether to be polled is used to indicate whether the STA will be polled in a polling phase of a trigger based measurement instance.

14. The STA device of claim 2, wherein
the target duration is a predefined timeout period, or the target duration is a timeout period indicated by the AP.

15. An AP device, comprising a processor and a memory, wherein the memory is configured to store a computer program, and the processor is configured to invoke and execute the computer program stored in the memory, causing the AP device to perform:
transmitting first indication information to a station (STA);
wherein the first indication information is used to indicate new measurement setup and/or measurement setup termination with the STA within a target duration;
wherein the STA is an associated STA with the AP, or the STA is an unassociated STA with the AP.

16. The AP device of claim 15, wherein
the first indication information is transmitted by the AP in a polling phase;
wherein the first indication information is transmitted via a polling trigger frame.

17. The AP device of claim 16, wherein
the AP indicates that the STA will be polled in the polling phase when performing measurement setup with the STA; or
the AP defaults to polling the STA in the polling phase when performing measurement setup with the STA;
wherein the STA is an unassociated STA with the AP.

18. The AP device of claim 15, wherein the first indication information is transmitted via a measurement setup request frame transmitted by the AP to establish a target measurement setup with the STA.

19. The AP device of claim 15, the AP device further performing:
receiving an indication frame transmitted by the STA within the target duration;
wherein the indication frame is used to trigger the AP to establish one or more new measurement setups and/or terminate one or more existing measurement setups with the STA.

20. The AP device of claim 15, the AP device further performing:
receiving first capability information transmitted by the STA, wherein the first capability information is used to indicate whether the STA supports measurement that does not need polling.
